(19) United States
(12) Patent Application Publication
(10) Pub. No.: US 2015/0269632 A1
(43) Pub. Date: Sep. 24, 2015

(54) COMPUTER SYSTEM, PROGRAMMATIC PLATFORM AND METHOD FOR BUYING AND SELLING CONTENT INVENTORY AND/OR AUTOMATED BUY-SIDE AND/OR SELL-SIDE SYSTEMS FOR INTERFACING WITH A PROGRAMMATIC PLATFORM

(71) Applicant: Decentrix, Inc., Denver, CO (US)

(72) Inventors: Michael A. Ledwich, Denver, CO (US); Wayne M. Ruting, Denver, CO (US)

(21) Appl. No.: 14/664,758

(22) Filed: Mar. 20, 2015

Related U.S. Application Data
(60) Provisional application No. 61/968,222, filed on Mar. 20, 2014.

(51) Int. Cl. G06Q 30/02

(52) U.S. Cl. CPC G06Q 30/0273

(57) ABSTRACT

A computer-implemented programmatic platform for facilitating the selling and buying of content inventory for linearly and targeted delivery of advertising is provided. In one implementation, the platform comprises: a sell-side interface configured to communicate with a sell-side platform; a buy-side interface configured to communication with a buy-side platform; and a protocol configured for facilitating the transmission of sell offers sent from the sell-side platform to the buy-side platform. The offers comprise a list of saleable units with their CPM values available for purchase from the sell-side platform, and for facilitating the transmission of bookings from the buy-side platform to the sell-side platform via the buy-side interface to the sell-side interface, wherein the bookings comprise a confirmation of at least one of the list of offered sale units. In another implementation, a process determines pricing of a plurality of content inventory items achieving substantially optimized revenue delivered from available inventory.

### CROSS-REFERENCE TO RELATED APPLICATIONS

This application claims the benefit of U.S. provisional application No. 61/968,222, entitled “PROGRAMMATIC PLATFORM FOR BUYING AND SELLING CONTENT INVENTORY AND/OR AUTOMATED BUY-SIDE AND/OR SELL-SIDE SYSTEMS FOR INTERFACING WITH A PROGRAMMATIC PLATFORM” filed by Michael A. Ledwich and Wayne M. Ruting 20 Mar. 2014, which is hereby incorporated by reference for all it teaches and suggests as though fully set forth herein.

### BACKGROUND

### 1. Field

The instant invention relates to a computer system, programmatic platform, database and method for buying and selling content inventory and/or automated buy-side and/or sell-side systems for interfacing with a programmatic trading platform.

### BRIEF SUMMARY

In various implementations described herein, computer systems, programmatic platforms, databases, database structures, database data schemas, protocols for enabling fast and efficient data transfer into and/or out of a database and methods for providing an improved computer system configured to provide a system for buying and selling content inventory, such as inventory slots for advertising, are provided. In one implementation, for example, a programmatic platform may include one or more interfaces for communicating with a content inventory sell-side system and a content inventory buy-side system. One or more content inventory providers, such as radio, television, cable networks, MVPDs (Multi-channel Video Programming Distributor), newspaper, Internet or other content providers, may offer content inventory (e.g., advertising inventory) to one or more content inventory buyers (e.g., an advertising agency or advertiser) via the programmatic platform. In one implementation, a content inventory provider may offer content inventory via an automated sell-side system that interfaces with the programmatic platform to provide content inventory available for sale to one or more buy-side content inventory buyers. A content inventory buyer may similarly interface with the programmatic platform via an automated buy-side system to purchase the content inventory from one or more content inventory providers.

In various implementations, one or more standalone computer systems, programmatic platforms, databases, database structures, database data schemas, protocols for enabling fast and efficient data transfer into and/or out of a database and methods provide for a standalone automated sell-side computer system, platform and method and/or a standalone automated buy-side computer system, platform and method are provided in which an improved computer system and database are configured to efficiently and rapidly provide for buying and selling of content inventory. In other implementations, one or more system, platform, database, database structure, database data schema, protocol and method comprises two or more of these platforms. In one particular implementation, for example, an automated sell-side platform of one or more content inventory providers offers a wide range of content inventory to be selected for booking using an automated buy-side platform via a programmatic platform.

In various implementations, an improved computer system includes one or more specific improved databases, database structures, database data schemas, protocols for handling data that enable the improved computer system to provide real-time automated computerized system configured to provide for buy and selling of content inventory.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 shows a block diagram of an example programmatic platform and a plurality of sell-side platforms and buy-side platforms configured to interface with the programmatic platform for the purpose of selling and buying content inventory.

FIG. 2 shows an example process of programmatic selling and buying content inventory.

FIG. 3 shows example analysis components of a programmatic process of selling and buying of content inventory.

FIG. 4 shows an example system for programmatic selling of Target Custom Demo Impressions.

FIG. 5 is a schematic diagram of an example computing device.

### DETAILED DESCRIPTION

Advertisers and advertising agencies have purchased digital media inventory via automated processes for a number of years. Experience with these digital programmatic platforms has driven them to look at expanding their automated buy processes to the linear world of TV, Radio, Cable, Satellite, streaming media and other media types. Media business sectors that have significant unsold advertising inventory would appear logical candidates for early adoption of these initiatives. The automated nature of this model requires significantly less staff and back office services to manage the buying process, hence reducing the costs of purchasing from supporting media vendors which is very attractive to the buyers. Large agency groups have made announcements indicating they plan on purchasing half of all of their media buys programmatically in the future.

In one implementation, programmatic buying is an at least partially automated (reduced or minimalized human intervention) process of buying content insertions (e.g., advertising insertions) using a Supply Side Platform (SSP) configured to offer content inventory (e.g., advertising opportunities), and a Demand Side Platform (DSP) configured to purchase that content inventory (e.g., those advertising opportunities). In advertising campaigns, for example, the metrics of the booked campaigns are generally expressed as target audience impressions. The target audience impressions can be delivered in any number of ways depending on the particular type of media delivery and/or content. In the example of Local Cable Television scenarios, target audience impressions are mostly delivered as broadcast video spots within a network and SysCode (the national identifier of a delivery area). In various implementations, specific database structures, data schemas and protocols are used to ensure an efficient and rapid processing and handling of data to enable the SSP and/or DSP to offer and purchase content inventory, such as via a real-time programmatic buying and selling platform.

Programmatic buying in the digital world is highly automated and advertising agencies have become attracted to the relative efficiencies of low staffing to manage these buy models. The delivery efficiency of the campaigns can also be high because of the ability to rapidly make automated selections over a potentially large set of publishing platforms and offered inventory. The origins of programmatic buying came from Real Time Bidding (RTB) for impressions where the Demand Side Platform (DSP) dynamically changes the CPM (cost per thousand impressions) that will be paid for the impressions and monitors the resulting delivery to achieve the campaign goals. The Supply Side Platform then displays the ad to each viewer based upon the best CPM offered within the target parameters. In one implementation, this model of programmatic buying requires real time communication of impressions delivered back to the Demand Side Platform and real time CPM communication to the Supply Side Platform insertion engine. Only some limited local cable television insertion models (for example VOD Pre-rolls) can support the Real Time Bidding model.

In the particular example of programmatic buying for local cable television, programmatic buying for local cable television is generally constrained to be Non Real Time Bidding (NRTB) models for programmatic buying to automate the booking process. In this case, the CPM is contracted as a fixed value in advance, as is the impressions goal for the specified target demographic. The Supply Side Platform takes the responsibility for achieving the number of impressions ordered and invoicing the delivered impressions at the contracted CPM. This NRTB model is applicable when the detailed campaign delivery metrics cannot be delivered back to the DSP in real time, or when the real time changes to the ordered CPM cannot be accommodated by the television advertising insertion system (the advertising trafficking and the headend insertion system).

MVPDs (in this instance local cable and satellite) control the direct delivery of advertising content to viewer platforms i.e. with Set-Top Boxes (STBs). These STBs have been able in recent times to gather the individual viewing transactions related to that direct delivery of the content to the viewer (the STB data). Analysis over these individual viewer transactions has allowed the direct measurement of accurate audience delivery metrics that are not available from the much smaller sample size of traditional sampling survey providers such as Nielsen. This has created the opportunity for these operators to sell additional impression based campaigns where previously there were no audience metrics (or insufficient metrics) to support authentication of the delivery of the campaign. Also, the direct analysis of viewer transactions supports rich custom demographics for individual campaigns and delivery of impressions that are not able to be supported by the traditional sampling survey providers with their small sample sizes. Fundamentally, programmatic selling based on this rich STB data provides an opportunity to value and sell “long-tail” inventory that was previously invisible and had no alternate audience measurement available. Also, additional target demographic audiences can be offered from the STB data that were not previously measurable. The result is a trove of granular targetable demographics previously unavailable to advertisers that can now be tapped by advertising agencies and advertisers.

With impression based campaign buying and selling being automated by a programmatic model supported by formal and rich databases, data schemas and protocols configured to provide an improved computer system capable of providing the impression based campaign, the traditional spot placement bookings (Spot campaigns) can be complemented by this new metric-based booking with target demographic impression goals and CPM rates (termed Impression Campaigns). Because the detailed inventory attributes are offered to the Buyer's DSP platform for processing, the advertising purchased can be expressed either as impressions or as spots. In this way, the programmatic buying platform can support both Spot and Impression based bookings over the same inventory. Note that in some implementations the Programmatic Buying platform is capable of taking bookings in parallel with traditional manual booking processes over the same inventory.

Traditional impression contracts for linear media use average survey audience as the impression delivery measurement and have been constrained to Nielsen demographics as the target (the classic media industry age/sex demographics). These campaigns (Type LNI—Linear Nielsen Impression) are delivered as broadcast insertions so that all viewers are shown the same ad. These LNI Nielsen Impression campaigns are candidates for programmatic buying.

With STB data (individual viewer transactions), subscriber content delivery events are being captured for analysis, and new custom demographics can be chosen for the target impression goals and CPM for broadcast delivery. The measurement is a direct count of the insertions to the subscribers specified by the custom demographic. This Linear custom target demo impression campaign type (Type LCI—Linear Custom Impression campaigns) is also a valid model for programmatic buying and an effective model using existing delivery systems. Since these custom demographics can be are measured by counting the viewer transaction, they can effectively be treated as additional “Nielsen like” demographics alongside of the standard Nielsen Demographics. However, because the measurement is counted from STB transactions rather than sampled (with small sample sizes), significantly more inventory can be included for sale, expanding the inventory offered and expanding the opportunities for advertisers and their agencies.

New insertion mechanisms are now available for direct-targeted insertion of advertising using either the STB or a streaming server as technologies continue to evolve. From the Buyer's perspective, these new campaigns (Type TCI—Target Custom Impression campaigns) appear similar to the broader LCI campaigns but the Supply Side Platform (SSP) delivers ads only to the target subscribers to achieve the impression goals. Again, these TCI campaigns are suitable for programmatic buying, but the protocol messages for optimum or improved buying and selling of these campaigns are different to those for linear delivered campaigns.

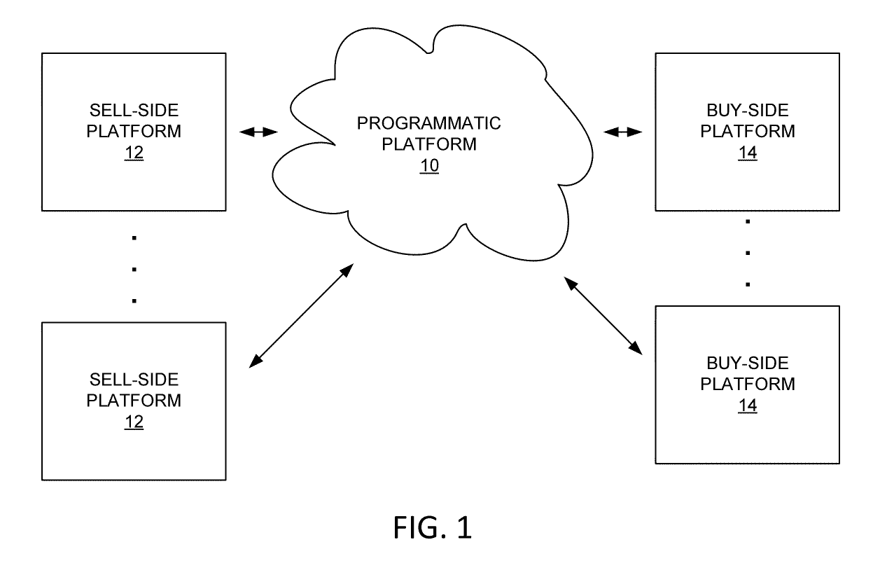

FIG. 1 shows one example of a programmatic platform 10 for buying and selling content inventory. In this implementation, one or more automated buy-side systems 12 and one or more sell-side systems 14 interface with the programmatic trading platform 10. The sell-side systems 12 may be used by any one or more content providers that have content inventory (e.g., advertising inventory) to offer for sale to one or more content inventory purchasers via the programmatic platform 10. The buy-side systems 14 may similarly be used by one or more content inventory purchasers to purchase content inventory

The programmatic platform 10 provides a protocol, examples of which are described herein, for allowing the sell-side and buy-side platforms to communicate with each other via the programmatic platform 10. Each of the sell-side platforms 12 and the buy-side platforms 14 can develop independent logic and rules for offering or purchasing content inventory via the programmatic platform 10.

In one particular implementation, for example, a linear sell-side module platform 12 is provided. A linear sell-side module platform 12, however, is merely an example of a type of computer system, programmatic platforms, sells-side platforms, buy-side platforms and methods that may be used within a computer system, programmatic platform 10 or method as described herein. For example, while in various implementations, a linear sell-side platform module may be used, other implementations, such as non-linear or targeted delivery sell-side platform modules are also contemplated for use within a system, platform, database, data schema, protocol and method described and claimed herein.

In one implementation, for example, a sell-side platform 12 comprises a module including set of data warehouse components to support the management of a Server Side Platform (SSP) of programmatic selling for both inventory management and optimum/improved rate calculations for a multichannel video programming distributor (MVPD). In one implementation, a module provides processes to define the set of Sales Units that will be managed to form the basis for making programmatic Offers. Further processes calculate reference Spot Rates, Availability, and projected audience for these Sales Units and update a Sales Unit database used for real time Programmatic selling. A linear SSP module manages the automatic selling of advertising delivered as broadcast events where all viewers are shown the same ad for one timeslot. In this particular implementation, it supports the optimum or improved selling of advertising delivered linearly (uniformly) during one timeslot rather than personally targeted. The SSP module does expect that a mixture of impression campaigns and traditional spot booking campaigns will be sold over the same inventory and provides support for selling either campaign type. An impression based contract specifies the total number of impressions of a target demographic that is the contracted goal, together with the Cost per Thousand (CPM) contracted for those delivered impressions. In one particular implementation, the module may include at least the following components: a sales unit definition component, a sales unit SSP database, a sales unit update process and SSP network (e.g., web) services for communication with a buy-side platform (e.g., a Demand Side Platform DSP). The data warehouse, for example, may comprise modules to hold sales unit spots and breaks, apply a projected audience to the breaks and to measure a campaign impression delivery.

A sell-side module, for example, may be designed to increase or maximize a content inventory supplier's revenue from their available content inventory when taking programmatic campaign bookings. It should be noted that having a measure of the audience projected to be delivered is important for managing impression based programmatic buying. The projected audience, for example, can be created by analysis based on actual historical data, or modeled based on certain assumptions of the seller or the buyer. The traditional Nielsen audience measure does not provide a reliable audience measurement (if any) on the long-tail of low audience content, networks, times, or audience demographics (the sample size is too small and long tail inventory appears to have zero audience as a result). Moving to actual individual viewer transactions related to a direct delivery (as verified by STB viewer transactions) as a measurement source may be used to create revenue opportunities from this long tail inventory. In one implementation, Real Time Booking (RTB) campaigns may place one or more decisions that affect revenue in the hands of the DSP (the buyer) and only the type and amount of inventory to offer for RTB is to be decided by the SSP. For NRTB campaigns, the SSP both sets the CPM and manages the inventory contracted so that the inventory goals of all the orders taken can be delivered—the SSP is in control of the inventory offered and the price for that inventory. The goals that are supported for maximum or improved revenue, in one implementation, are: setting and adjusting pricing to modify demand, and monitoring available inventory for orders to prevent (or reduce) overselling of inventory.

Programmatic buys, by definition, require automation between the SSP and DSP to place the orders. For NRTB campaigns, for example, an order is fixed and agreed in advance and the SSP is then responsible for delivering the impression goals of the campaign. The first task of the SSP is to provide information (Demos & Offer transactions) to the DSP necessary for the DSP to place orders. The next task is to receive the campaign headers and the campaign lines (Bookings) electronically from the DSP. The SSP then validates the details of the requested campaign, accept the valid lines (Confirm) and communicate the rejection reason for any unacceptable lines. In one implementation, unacceptable booking requests include: a CPM less than the current selling rate, a Sales Unit that is not currently saleable, a target demographic that is not currently supported and an inventory goal that exceeds the available threshold. Another task for an SSP is communicating the campaign delivery (Delivery) during a delivery phase of campaign. In one implementation, for example, supported transaction types include: a list of currently supported audience demographics supported by the SSP, a specification of a campaign header attributes by the DSP, a list of saleable sales units and CPMs available from the SSP for a campaign, a campaign line bookings from the DSP that are confirmed or rejected and a supply of delivered impression totals for a campaign line.

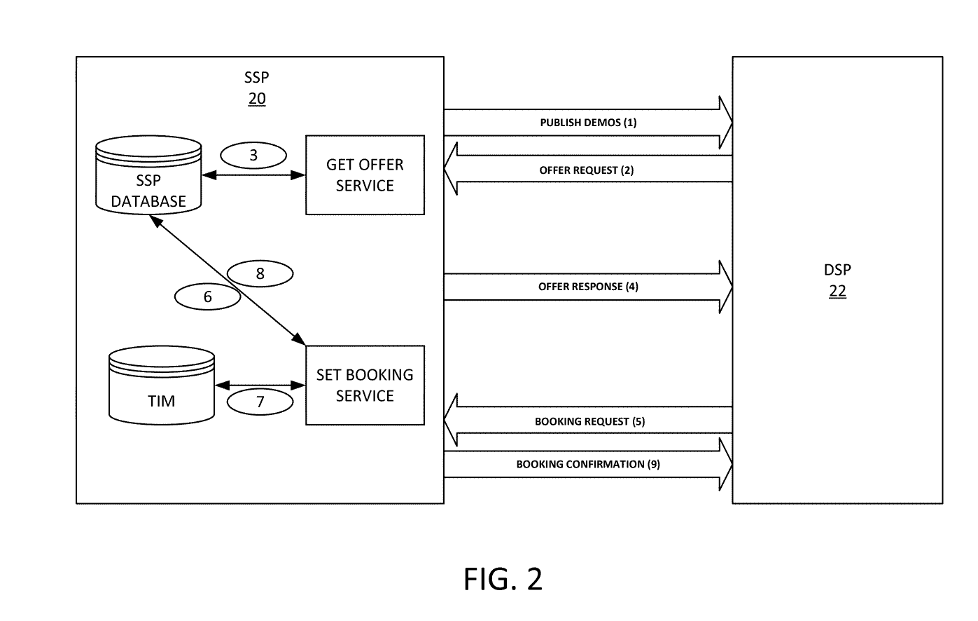

FIG. 2 shows an example of a process for facilitating buying and selling content inventory between a sell-side platform (SSP) 20 and a demand side platform (DSP) 22. The SSP 20 and DSP 22, for example, may be communicatively coupled via any type of network or other communications system, such as, but not limited to, the Internet, an intranet, a local area network (LAN), a wireless LAN, a wide area network (WAN), or any other type of network or computer communications system. In this implementation, the SSP 20 publishes a list of currently supported demographics to the DSP 22 via the programmatic platform (Operation Publish Demos (1)). In response, the DSP 22 issues an offer request including a specification of campaign header attributes (Operation Offer Request (2)). The SSP 20 responds to the offer request with an offer response providing a list of available “Sales Units”, spot rates, and CPMs from the SSP. The DSP 22 issues a booking request (Operation (5)) in response to the offer response that includes bookings that are confirmed or rejected by the SSP 20. The SSP 20 then issues a booking confirmation and delivers the impression totals (e.g., for one or more campaign lines) (Operation Booking Confirmation (9)).

In one implementation, for example, web service connections are be authenticated to a user account. User accounts in a database (including the system users for the DSPs) are grouped into Buying Accounts that generally correspond to Agencies or Advertisers. These Buying accounts are “Authorized” for trading before the web service will interact with the DSP systems. This security component of the SSP API monitors and authenticates the allowed trading parties.

As described above, the Offer Response from the SSP includes a list of saleable Sales Units. The inventory to be sold by the SSP is organized by Sales Units that group advertising (or other content inventory) slots together for valuation, tracking, and sale. These Sales Units could be programs, dayparts, or multiday dayparts. Sales units can overlap (a daypart can be sold as well as individual programs in the daypart).

In one implementation, Sales Units are either Base Sales Units that are directly defined over the breaks, or they are Group Sales Units defined by a list of Child Sales Units. This defines a strict hierarchy of all Sales Units that creates some limitation on the flexibility of what can be priced and sold, in exchange for having a clearly structured analysis of the inter-relationship of all the Sales Unit bookings. Each Sales Unit will have a Priority for the spots booked to that Sales Unit.

When inventory calculations are performed, they can be accumulated over spots of all priorities higher than the Sales Unit's priority. In one implementation, for example, the convention for priority may be that smaller integers are considered to be the higher priority. For example, consider the following Priorities: (2) Program (highest); (3) Day Daypart; (5) Multiday Daypart and (6) ROS (run of station and lowest in this example). Further consider the following example for the Arts and Entertainment Network for Sales Units: (1) Duck Dynasty—Tuesday—Base Sales Unit—Priority 2 and (2) Prime Daypart—Tuesday—Group Sales Unit—Priority 3.

In this example, Sales Unit 1 would be assigned to all the breaks and spots in the A&E network from 8 to 9 pm on Tuesdays. The definition of Sales Unit 2 will be a list that includes Sales Unit 1. The inventory position of Sales Unit 1 would be the capacity less all the spots with priority 2 or higher (0-2). The inventory position of Sales Unit 2 would be the capacity less all the spots with priority 3 or higher (0-3). The projected inventory position can be calculated for all Sales Units that are part of Sales Unit 2 and this can be subtracted from the capacity for Sales Unit 2. Thus the remaining inventory that will not be sold at priority 2 will be derived. The projected sales just for Sales Unit 2 can be checked and if they project higher than the remaining capacity, then the Sales Unit 2 can be withdrawn from sale to have the higher revenue overall.

Because this particular analysis example is limited to the selling of broadcast events (this application, however, is not so limited), then the Sales Unit rate can be applied to either spot purchases or impression purchases. Impression contracts are generally specified as an overall target number of impressions for a specified demo together with a CPM that will be charged for the impressions. But it is appropriate to both construct and record such impression orders with detailed lines of Sales units with the number of spots planned to achieve the overall total impressions. This allows a real time preparation of the impression campaign proposals which includes the calculation of the optimum CPM for a specified target demo together with the calculation of the availability of the impressions requested.

In this example, the calculation proceeds with a standard approach of ranking the Sales Units by increasing CPM for the target demo together with the removal of any Sales Unit that is not currently Saleable. The Buying System can chose the Sales Units desired from the offered list and the number of spots in each to achieve the total number of impressions. The overall CPM can simply be calculated by the total cost of the spots together with the total impressions delivered.

Offering a detailed impression contract to the Buyer allows custom selection of the Sales Units considered to be of value to the Buyer Campaign, but also adjusts the resulting CPM because of the selection made. It also allows the inventory position of all impression contracts to be managed. This is because it is expressed as the sale of Equ30s (equivalent 30 second spots) in each Sales Unit which can be checked against the remaining inventory of each Sales Unit.

To support the Impression booking, each list of available Sales Units provided for purchase should contain a maximum number of Equ30s offered for sale. This will be the minimum of the remaining capacity and a nominal maximum number of spots per hour. Also provided is the average audience for the target demo during the Sales Unit. This translates the number of Equ30s chosen to the projected impressions provided.

Section A below further provides a detailed list of Linear SSP API Transactions for a linear programmatic sale and purchase system.

From a seller's perspective, a goal of the SSP is to maximize or at least increase the revenue delivered from the available inventory. The role the analysis plays in the SSP in maximizing/improving that revenue differs by the various campaign types. For contracting business for NRTB campaigns, for example, where the CPM rate and the contracted impressions are agreed in advance, some common principles exist: (1) contracting for more impressions than are possible cannot be allowed (inventory does not exist); (2) unsold inventory of impressions normally means lower total revenue than the potential (since saleable inventory remains); (3) the forecast of future impressions should be as accurate as possible (since imprecise forecasts will result on oversell or undersell at final broadcast time); and (4) the demand for each type of inventory should be forecast accurately to minimize changes to the contracted CPMs.

In a linear inventory management example of this application, preventing over selling of inventory is a primary responsibility of a NRTB SSP system. The Linear inventory is separated from any targeted delivery inventory but is shared with the booked spot campaigns. The sum of all linear impression and spot campaigns is be accumulated and compared to the capacity. To achieve this, the linear impression contract details are converted to Equ30 spots for both the capacity and the sold spot metrics. This is a valid calculation for linear delivery of impression contracts.

The linear traffic systems (e.g. Novar. Eclipse, but also many others) perform the scheduling of all linear delivery spots and project transmission times for the spots so that the SSP analysis of capacity and sold spots is accurate to a fine granularity. The inventory likely to be sold by the sell side proposals, as well as the inventory committed real time by a programmatic buy, is added to the booked inventory to fully identify committed inventory when compared to the available inventory.

For linear delivery, the Equ30 rate for a slot is the primary pricing decision for all insertions. This single rate is used to derive all of the CPM values so that, no matter which campaign type (impression or spot) fills the slot, the same revenue is achieved.

An initial value can be derived for a future Sales Unit by forecasting the audience for a list of basic target demographics and then using the market based commodity CPM over those demographics to derive a set of values for the slot. The maximum value is chosen to reflect that the slot will be sold to the advertiser who attributes the highest value on the slot. Refinements to this simple maximum are a part of the application including utilizing historical pricing trends and also an approach to average a set of the highest values rather than just one. The Sales Unit priority is also used to scale the rate.

When orders start to occur for each future Sales Unit, the pace of orders is compared to historical (or reference) pacing and used to forecast the final sellout position. This information is used to adjust the Sales Unit value. This, in turn, ranks the Sales Unit differently for any CPM ordering and will either lead to higher revenue from the demand or more sales at a lower rate.

Linear delivery has the same ad viewed by all viewers within the break. This means that all viewer impressions are delivered even though the buyer has indicated that they are buying a subset demographic of viewers and that subset is all that counts. With Linear delivery, there is not the option for the seller to use the unwanted viewer impressions to make more revenue by selling those unwanted impressions again (since the slot is taken across the total audience viewing). The total value of the spot's viewer impressions is consumed by every ad broadcast. So the value of the slot to the MVPD is a single value independent of the stated target demo audience selected by the buyer. Thus the calculated value of the Equ30 (Equivalent 30 second) slot should be used for all campaign evaluations regardless of the target demo. Note that it is true that a high valuation from buyers for a Sales Unit should be used to raise the price of the Sales Unit, but that increased rate should be used for all buyers of the Sales Unit.

By way of example, one characteristic of the optimization approach described above and in Section A below is the calculation for every instance of a Sales Unit of the Salability flag (if a Salability flag is set then inventory is available to sell). The calculated inventory projections and capacities are held in the SSP database together with the current sellout level. A Salability flag is set naturally by the loading of these values into the SSP database and clearing the flag if there is no remaining inventory. This prevents any Sales Unit that would exceed the inventory capacity from being offered to buyers through the SSP interface. Note that the list of Sales Units includes narrow high priority periods together with overlapping broad low priority periods. The Salability flags are calculated independently for both high priority (higher rates) and low priority (lower rates) Sales Units and only appropriate inventory is shown to the Buyer. Note also that each Offer (sometime referred to as an Avail) communicated to the Buyer DSP is a limited list of the top Salable Sales Units when ranked by the CPM. So only Sales Units efficient for the Target Demo requested are offered to the Buyer.

A number of automatic (rule based) calculations are performed in real time by the SSP system. First, the SSP database is refreshed each day with rates, new inventory projections, and current sales levels. The actual bookings that occur during the trading day increment the sold impressions and dynamically switch the Sales Unit state to not Salable when appropriate. However, any higher rate, higher priority included Sales Unit will still be offered for sale—effectively raising the rate that Buyers will pay for similar inventory. This is because the included (children) Sales Units reserve their projected inventory. Note that the inventory calculations will always place higher priority bookings first and thus the first Sales Units to be withdrawn from sale will be the lower price Sales Units. Although not a constraint of this application, since the actual clearing of bookings and inventory in an NRTB system is delayed and often processed overnight as a result of the current trafficking systems deployed, then the overnight recalculation of the forecast inventory sellout is the base calculation that changes the rate for the next day's sales if the projected sold inventory is above the capacity. With the paced forecast model in the SSP (which operates independently of the trafficking systems), the Rate is automatically incremented during the trading day if the projected volume of sales exceeds the capacity. On a daily basis, the calculation checks for rates that are too high. This calculation includes the usage count of the Sales Unit in Offers as well as the projected sellout percentage. Then the rate increment percentage is applied to lower the rate.

In this example, a basic policy for pricing Sales Units is based upon projecting the sellout of inventory. If the current projection prediction is that demand will sell the entire inventory (or more), then the price should be raised. Any Sales Units where there is a very low rate of selling at the current price will have the rates lowered. So projecting the sellout level accurately is performed by the algorithm in this application.

The past pacing history for the same program last year is also a valuable reference of the pace and envelope of the demand leading up to the future transmission. However, if the rates were changed during this period, then the historical pacing is biased by the changes of price.

In one implementation, consider a price demand relationship where the demand D is a linear relationship to the price P as in D=R*(1+S*(P−PR)/PR) where R is the demand at price PR and S is a negative Sensitivity. So if the sold units on the same pacing date were UP and the future units sold was UF, then the projection multiplier would be UF/UP. But if the rate up to the pacing date was PP and the price after the pacing date was PF, then the demand change because of price would be UF=UB*(1+S*(PF−PP)/PP).

So UB=UF/(1+S*(PF−PP)/PP); and the real pacing ratio of demand with price excluded would be UB/UP=UF/UP*(1/(1+S*(PF−PP)/PP)).

All of the sold Sales Units transactions are saved to a Staging table of the Real Time Inventory Engine which is a part of the SSP. This staging table is cleared each time the main processing extracts all the data each night. So these additional sales are processed on a real time basis to calculate the incremental sales Equ30s. These sales are processed against the Sales Unit being booked. The changes to the remaining capacity are checked to either increase the rate or to clear the Salability flag.

Whenever a Sales Unit rate is raised higher, the CPM of all of the demographics that could be purchased is raised. This will place this Sales Unit further down the ranking of efficient Sales Units and will make it less likely that that it will participate in proposed or booked campaigns. Thus the result is that demand should be directly lowered by an increase in the rate of a Sales Unit.

When the Sales Unit rate is lowered, then the CPM for every demo will be lowered. This will move the Sales Unit up the CPM ranking and will cause the Sales Unit to be more attractive and selected in more proposals. Thus more of this Sales Unit will be sold.

The derivation of rates proceeds from macro calculations across all Sales Units to the micro management of rates for individual Sales Units.

An initial step in this process is to manage the CPM values for the reference demographics that will be used to value inventory. The list of reference demos is based upon the availability of market CPMs (such as SQAD data . . . ) and the relative popularity of this demographic with Buyers. For example, most booked and proposed campaigns should have the primary target demo specified to classify the target being purchased. Then the average CPM being purchased can be calculated over the recent and future months. The SQAD CPM rates can also be compared and the Selling CPM values set for the small number of reference demographics.

Every Sales Unit instance has the average audience projected for all demos including the reference demos. Thus a spot rate can be inferred for each demo using the projected average audience and the reference CPM specified. The first rate recommended for each Sales Unit is the maximum of these rates over the reference demos. Thus every Sales Unit can have an initial value calculated and also identify which reference demo was used to derive this maximum value.

A further analysis can derive the overall demand (total impressions per week) for each reference demo and compare this to the inventory priced just for this reference demo. Where the inventory priced for a reference demo significantly exceeds the demand, then this demo is dropped from pricing for the excess inventory.

A conversion efficiency is derived as the ratio of the demo average audience to a reference such as HH (Households). The Sales Units are ranked by descending Conversion Efficiency and the max rank is derived that delivers the inventory in demand. All Sales Units of higher rank have their MaxValue rate recalculated (to a lower value) with this demo excluded and they have the new reference demo recorded. This adjustment to actual demand proceeds with additional reference demos, in each step excluding the previously processed reference demos.

Sales Units have a priority associated with them to reflect the flexibility of scheduling. This is proportional to the number of hours of transmission covered by the Sales Unit. Parent Sales Units have by definition more transmission time and also a lower priority. Calculations of the value of this flexibility compare the CPM of sold inventory at the different priorities. This is reflected in a rate scale percentage that is applied to the more flexible Sales Units.

Some Sales Units have demand in excess of the value derived just from the reference demos. This can be measured historically by the calculation of a rate multiplier between the historic rates paid for the Sales Unit and the MaxValue rate. This Sales Unit Rate Multiplier can be derived and applied to a limited list of Sales Units where the Rate Multiplier is above a selected threshold.

Section A below further provides an example of a linear SSP schema in which a database used to support linear offers has a number of tables and describes those tables in detail.

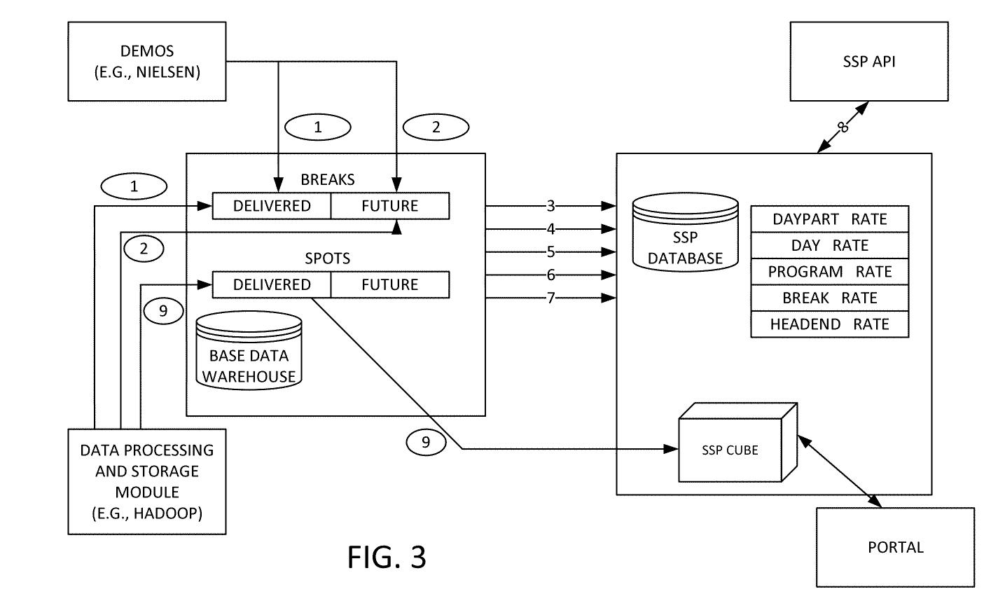

To support the programmatic transactions, a Linear SSP Module utilizes a number of processing steps performed by other modules as shown in FIG. 3. Further, in the particular example shown in FIG. 3, the analysis of components of this particular example programmatic selling for linear spots and impressions include the following operations shown in FIG. 3:
1. Load Nielsen Audience or the Custom Audience onto Breaks (future Sales Units) (Campaign Performance Module).
2. Project the future Nielsen or Custom audience for future breaks (Campaign Performance Module).
3. Analyze and save the initial Max Value Rate per Sales Unit using market CPM on dominant demos (Linear SSP Module)
4. Forecast paced orders to modify initial rates to provide the MaxRev Value Rate and load the SSP database. (Linear SSP Module)
5. Update the SSP database Sales Units with the CapacityEqu30s, the PriSoldEqu30, and the ProjPriSold Equ30s. (Linear SSP Module)
6. Update the impressions per spot for the Nielsen and custom Demos. (Linear SSP Module)
7. Use the forecast paced orders to set Salability Flag or the rate increment and update the SSP database. (Linear SSP Module)
8. Validate incoming booking requests using the SSP database values. (Linear SSP Module)
9. Update the current sales and adjust the Saleable flag or the current rate increment.
10. Load Nielsen or Custom delivered audience onto the spots for the spot target audience to show the campaign delivery (Campaign Performance Module).

Section B below describes a Campaign Performance Module definition for an example content inventory sale and purchase system.

In one implementation, a system for managing and optimizing (or at least improving) programmatic selling campaign delivery is provided as described herein. In one particular implementation, for example, roles of viewer transactions together with the traffic data are provided to perform an analysis to manage and optimize (or at least improve) the programmatic selling campaign delivery. Also, SSP web services support an automatic buyer's Demand Side Platforms (DSPs), and data flows for both the optimization analysis, and the trafficking of the campaigns. Solutions for automating a CMS Supply Side Platform are also provided.

Section C below describes an example implementation of a Targeted SSP Module. In this implementation the model includes a set of data warehouse components to support the management of a Supply Side Platform (SSP) of programmatic selling for both inventory management and optimum rate calculations for the targeted delivery of ads by a multichannel video programming distributor (MVPD). The Targeted SSP Module manages the automatic selling of advertising delivered as individually targeted events where the household attributes are used to select a targeted ad. An impression based contract specifies the total number of impressions of a target demographic that is the contracted goal, together with the Cost per Thousand (CPM) contracted for those delivered impressions. This Module includes the following components: an average and over-lap Audience loader; a Targeted SSP database; Targeted SSP Web Services for the communication with the DSP; and an interface to the targeted insertion module (e.g. Visible World).

### Example Targeted SSP for Local Cable Television

### Background

In one implementation, targeted advertising for Local Cable Television uses either the flexibility of streaming video insertions or STB overlay insertions to deliver custom advertising content for viewers, dependent upon viewer attributes. Targeted advertising contracts may have a contracted CPM for the specified target demographic that sets a value for each viewer insertion. In addition, an advertising copy to be inserted can be specified and dependent upon additional viewer attributes within the contracted target audience. In many implementations, there is a default copy to be used if no sub demographic targets are met. The targeted insertion engines may have a list of all such active contract lines and, for each viewer insertion opportunity, uses this list of contract lines to make a real time decision for the best contract and copy insertion for that particular viewer. The viewer attributes are compared to the target attributes for each available contract line. The contract lines are sorted by decreasing CPM (highest value) and the first contract line that fits the viewer attributes is chosen for insertion (limited by spot separation policies).

Because the insertion logic is not explicitly dependent on the placement in a network or time or content, then the ad impression for a valid target viewer is considered to be equally valuable across all inventory slots. An impression to a specified viewer in prime time on a top network is considered to be of identical value to an impression to a contracted viewer overnight on a low tier network.

Although the targeting of copy within a contract is fully supported by the insertion engine, the optimum CPM rate and inventory management of the booking is independent of the targeted copy instructions. This module manages the programmatic buying of the targeted contracts but does not include the communication of the targeted copy instructions. It can appear unclear in a targeted campaign whether the instruction is only a copy insertion instruction or whether it is an independent targeted booking. The rules are that copy instructions target demos are subsets of the booking target demo, and that there is a default copy instruction just to the booking target demo. These campaigns are priced for the booking target demos and not for any of the copy target demos.

### Target Attribute

In practice, there can be many characteristics included in the definition of the target demographic for a targeted contract. They all combine to define for every viewer whether they are counted towards the targeted impression goal. These characteristics can be geographic, household properties, viewing behavioral, or purchase behavioral. Sometimes the subscribers are individually flagged by trusted third parties to explicitly define an advertiser's target audience. Most attributes have to be at the household level rather than the STB level because of the current inability to know which household members are viewing a particular STB at any time. In the future, this ability will become possible for STBs (e.g. Xbox One television viewing). Behavioral attributes based upon a STB rather than a household could be used to improve individual targeting (e.g. identifying STBs used by one viewer in say a household bedroom). So classic age and sex attributes of individual viewers are not normally supported in the target characteristics but related household attributes can be (e.g. the household has children under 5).

The targeting characteristics of a contract can be quite complex but are general summarized down to a single custom attribute possibly used only for one advertiser campaign. These single summary attributes become the definitions of the custom demographics supported by the Targeted SSP System. Note that some of the demos and custom demos used for linear impression contracts cannot be used for targeted contracts and vise-versa.

Because the number of custom demos used for targeting can be quite large, and because the inventory management is performed on the overall inventory, the metrics for targeted custom demographics are derived and stored only for the overall analysis and not for every advertising slot. Thus the analysis of the targeted custom demographics audience is quite different to the analysis of the smaller number of custom demographics used for linear advertising contracts.

### Insertion Engine Rules

The rules that the insertion engine uses to choose the ad content to display is well defined and transparent to be able to build a predictive inventory management system for such an insertion engine.

It will be assumed that all targeted contracts are essentially defined by the custom target attribute of viewers, the CPM that will be paid for each impression, and the goal of impressions to be delivered each week. It is also assumed, by an inventory management system, that the ad is chosen to be the highest CPM contract that matches the viewer's attribute. Inventory management is based upon a prediction of the future viewing audience, and actual delivered statistics will always differ. Most insertion engines can bias the contract chosen towards contracts that are falling short of their goal of impressions but this effect is ignored by the inventory management calculations.

### Inventory Management

The inventory allocated to targeted insertions is carved out and kept separate from other inventory. However, this carved out inventory is considered to be all equally suitable for targeting for all targeted contracts. Thus the management of available inventory is undertaken at the granularity of a broadcast week across all networks and dayparts of the inventory pool assigned to this targeting selling type. The management of the pricing and inventory is undertaken for each offered target demographic.

The definition of the carved out inventory dedicated to targeted delivery is used by the STB audience analysis subsystem to derive both total impressions metrics as well as the demographic overlap percentage matrix. Thus the derived metrics are applicable to the inventory allocated for targeted delivery.

Geographic targeting can be included in an attribute for a campaign. This can simulate booking to one or more headends. It will be assumed that any contract that does not include geography in its target attribute can be contractually delivered with uneven geographical delivery. Thus targeting campaigns are generally offered for only one overall SysCode with the option of custom geographic targeting within the defined demographic.

Thus, in summary, inventory management is performed overall for each future broadcast week across all targeted custom demographics. The algorithm follows the rules of the actual insertion engine and thus assumes that the contract with the highest CPM will be filled first before the inventory of impressions is available for contracts with lower CPMs.

### Target Inventory Calculation

Inventory is carved out each week for targeted delivery sales. The supported target demographics are defined by attribute flags on the Account dimension. The carved inventory is normally not defined by a range of days or times, but by large quantities of placeholder spots. To perform predictions of the amount of impression inventory is available for sale, then it is desirable that the number of spots and their distribution is reasonably stable. For example, if DR spots are used as filler, it would be reasonable to expect that the number and distribution of such spots does not change much week to week.

If there are multiple sets of inventory separately assigned as independent targeted sales pools, (such as Interconnect and Local), then they are identified by a Targeted Pool Type. The number of spots in each targeted pool within each Sales Unit is extracted from the traffic data warehouse to specify the quantity and distribution of insertions. This specification of the number of spots per Sales Unit of the Target Pool is applied to the counted average audience for each Sales Unit to calculate the total impressions capacity per week for every one of the targeted custom demographics. These values set the weekly impression capacities for every target demograph in the SSP database for each Target Pool.

### Buyer CPM Contract Types

The primary model for NRTB targeted contracts is that the Seller specifies the CPM price for a requested target demographic and impression goal, and guarantees to deliver the contracted impression goal. However, a Buyer could be theoretically allowed to propose a lower CPM as long as the buyer took the risk on achieving the impression goal. The insertion engines will deliver to a lower CPM contract on fewer occasions and thus would be likely to fall short of the number of impressions. Inventory management systems calculate and reserve sufficient impression inventory based upon the CPM ranking and can predict the amount of impressions that will be available at each CPM value to assist in booking acceptance or rejection. While there is only a limited pool of buyers, and while there is an excess of inventory, allowing a Buyer to offer a lower CPM will result in their goals being delivered at the lower price. This will drive down the prices and revenue until the number of buyers and their demand is grown to match the amount of inventory offered. Thus it is not recommended to take Buyer offered lower CPMs until the Buyer demand pool grows to exceed the offered inventory.

The design of this module does not recommend or support allowing a Buyer to offer a lower CPM than the optimum calculated market rate offered by the Seller.

### Initial CPM Pricing

Buyers can purchase impression based advertising campaigns by contracting for linear delivery of ads but with a CPM contract and an impressions goal for a specified target demograph. The Linear SSP calculations can derive the CPM for the best campaign for this target demo and the impression goal. From the Buyer's perspective, asking for targeted delivery does not change the explicit campaign delivery as observed by the targeted viewers or by the advertiser. The only difference is that, for linear delivery, there are wasted delivery impressions to viewers outside of the target demograph. If the buyer values these extra impressions, then they should contract for linear delivery. Given that almost all television delivery is linear, then the Buyer would currently be paying the Linear optimum CPM for the special target demo. Thus it is recommended that the initial CPM for each target demo for targeted delivery is set to the Linear Optimum CPM for that target demo.

To calculate this, then the Sales Unit average audience for all of these target demos needs to be loaded directly into the Sales Unit database of Linear SSP and an optimum Offer calculated for each target demo.

### Target Demo Ranking

The CPM for target demos with a small universe will be higher than other target demos with a larger universe. The insertion engine and the matching inventory management model will thus give the impression inventory first to the smallest universe Target Demo. It will turn out that the higher demos are thus mainly removed from the delivery given to the larger universe demos. Thus if households of very high income are an in demand target demo, then all such households are going to be removed from the delivery of lower CPM target audiences. For example, the households who took a cruise last year might be a specified target audience for an agency campaign. Both the Buyer and the Seller need to be aware that the delivery of Cruise Takers will only be to the low income Cruise takers in this example. This could in extreme cases make the lower CPM campaigns, such as the cruise taker's campaign, ineffective because there are no high income households included.

The effect can be quantified by observing the overlap percentage of all the higher CPM demos supported for the selling. Demos with little overlap do not cause this effect. If the CPM for an interfering demo is not much more expensive, then the CPM could be raised to be higher and thus remove any interference. The demos offered to an agency could be refined to explicitly include the interfering demo (e.g. High Income Cruise takers). There are benefits to the vendor to encourage competitive escalation of demographic definitions to avoid interference.

### CPM Increment

When a target demographic is forecast to sell out, then the CPM offered by the Seller should be raised to both increase revenue and also manage demand. It should be raised so that it is higher than the next higher CPM in the list of managed demos to have the effect of lowering the demand.

### Audience Data

The audience data required to support targeted campaigns consists of 2 components.

Firstly, the total overall number of independent impressions available for sale each week is forecast. This is often done with the latest data for STB transactions across the entire inventory carved out for targeted delivery. This forms a simple list of impressions totals for each custom demographic. They are calculated as independent totals even though there will be many overlaps in the custom demographics. For example, the sum of these independent impression totals will be much larger than the total for all STBs.

Secondly, a matrix of overlap percentages is required between all demographics. This specifies for each Demo 1, the percentage of impressions that can be counted for Demo 2. Note that this matrix has 100% for the diagonal items. It is also not symmetric in that the percentage of Demo 2 in Demo 1 is not the same as the percentage of Demo 1 in Demo 2. For N Demos, there will be N² values in the overlap matrix. Again, this is normally derived from the latest week of STB data. It is based upon impressions and not distinct counts of households and is correctly biased by the impressions available for each demo.

Note that using this matrix for calculating overlaps is only accurate to a second order and also that third order overlaps will not be used. This is basically because the process of inventory management is a predictive process with intrinsic statistical inaccuracy to start with.

### Program Watching

It is natural to consider including the network or program being watched as part of the target characteristics. The program or network being watched could be considered to be separate and in addition to a custom demo on the targeted campaign. However, the effect of targeting impressions into a particular program or network can only be understood and predicted if the overlap on all the other custom demographics is calculated. This can only be done if the Program/network watched is included in the custom demo definition. This may expand the number of custom demo definitions significantly. However, targeted delivery to those watching a program or network is efficiently delivered by a broadcast ad. Each custom demo for targeting requires a degree of analysis to support it. In addition to the audience statistics required from the STB, the dynamic pricing calculation for the custom demo is performed as part of every booking. So the number and type of custom demos supported is considered carefully to balance the value of the revenue against the cost of the analysis necessary to manage them.

### Targeted Inventory Calculations

The calculation for inventory management of targeted impression delivery has a number of steps.

The CPM for each managed custom demo is the driving parameter. It can be initialized before sales by the linear Rate for the sales units carved out for targeted inventory divided by the independent impressions for each of the supported target demos.

The managed targeted demos are ranked by decreasing CPM. This is similar to ranking by increasing impression count. So the very small demos are at the top of the list. This is to ensure that every viewer is given the ad that results in the highest revenue.

The first calculation is called the NoSale Pot Imp (Potential Impressions) and it is the simple independent count of the number of impressions for each of the target demos. This is the same as the total linear impressions for each target demo.

The next calculation is the MaxSale Pot Imp where in order of rank, it is assumed that all of the demos higher are fully sold and their overlap with the current demo is removed. So the MaxSale Pot Imp is always less than (or equal to, for the first demo) the NoSale Pot Imp. Note that for lower demos, this number can go negative given the second order approximations involved.

Then when sales are made, then the Current Sale Potential impression can be calculated. It takes the overlap from all of the other demo sold impressions from the current potential to leave a second order estimate of the remaining impressions for sale. This CurSale Pot Imp is then compared to the current sales for this demo. This comparison can become negative if impressions were oversold and this should result in any oversold inventory being made good in a later week. Of course this will result in this demo being flagged as Saleable=False. Note that all other demos that are sold are used in this calculation of remaining impressions whether they are higher or lower. The forecasting approach should be used to prevent selling low demos that prevent the future sale of higher demos.

Note that there can be demos lower on the ranking that are still for sale because there is little overlap with those demos. The amount of inventory that is to be reallocated to different weeks is the amount of negative impressions from this calculation.

So as sales occur, a number of different demos could go negative for the CurSale Pot Imp less the current sales. No further sales are taken for these oversold demos by setting the Salable Flag. The next calculation is to forecast the impressions that might be sold for each demo from the current sales and the pacing history—the Estimated Sale Imp—EstSale Imp. The paced historic impression sales are compared to the historic final sales volume and the current sales of that demo.

This EstSale Imp is calculated independently for each demo. Then, based upon the current ranking of the demos, this Estimated Sale Imp is used to remove the overlap impressions from the NoSale Pot Imp by the overlap matrix but only from higher demos. The actual sales from lower demos are used to find the overlap and subtract it. This is because all impression inventory should be reserved for the valuable demos first. Again, the current sales for this demo are checked against this Forecast Sales Potential Inventory. If it is negative, then the Saleable Flag is set to False to prevent any further selling of this demo by this Sales Unit.

So as sales proceed, the CurSale Pot Imp is reducing from the NoSale Pot Imp for each particular demo and heading towards the Max Sale Pot Imp. At the same time the current sales for this demo is rising from zero and hopefully not meeting the CurSale Pot Imp because that is the oversell point.

Similarly, the ForeSale Pot Imp is being calculated and becoming more accurate as sales proceed. The current sales for this demo is growing and when it meets the ForeSale Pot Imp, then the selling should stop with the Saleable Flag=0. Separately, the forecast sales for this demo can be compared to the ForeSale Pot Imp. If this is negative, then the CPM should be raised for this demo to adjust to the demand.

So there are 3 checks to have different actions:
1. The current sales are compared to the CurSale Pot Imp to detect overselling requiring movement of the bookings
2. The forecast sales for this demo are compared to the ForeSale Pot Imp and the rate is raised (or lowered) to accommodate the forecast oversell.
3. The current sales are compared to the forecast sales and the sales use is set to not saleable if it exceeds this threshold.

There could be both overselling demos as well as Not Saleable demos scattered in the list independent of the rank.

### Targeted Delivery Campaigns

Targeted delivery campaigns allow many different targeted spots to be delivered into the same advertising slot. But the 2 goals are shared with the broadcast delivery:
1. Never contract for more targeted impressions than will occur.
2. Contract each CPM at the highest level that will sell the impression inventory (maximize the revenue).

### Target Inventory Management

It is assumed that the inventory allocated for Target delivery is separated out from the inventory assigned for broadcast delivery.

The first approximation is that the CPM for targeted delivery so be almost the same as the CPM for broadcast delivery because the value to the advertiser is similar (the cost for the same number of impressions is the same). So the list of custom target demos to be offered for sale for a Sales Unit can be initialized to the “Broadcast” initial Value CPM. This can then provide a rank on the custom demos from a high CPM to a Low CPM. The next assumption for target inventory analysis is that the insertion algorithm will always try to insert the Ad with the highest CPM for that slot and viewer.

The first inventory threshold to be derived is the NoSale Potential Impressions which is the independent count of the total number of impressions for each custom demo within the Sales Unit. It is named as the NoSale value because it is only correct if there are no sales of any impressions for custom demos with a lower rank (higher CPM).

The next inventory threshold to be derived is the MaxSale Potential inventory which assumes that all custom demos of lower rank (Higher CPM) are fully sold out to their potential.

This is derived using the custom demo matrix of overlaps between the demos.

After orders are taken for a Sales Unit, the remaining inventory of impressions can be recalculated for every custom demo for the Sales Unit. Again, the custom demo matrix is used to derive the overlaps and calculate the CurSale Potential impressions.

The final calculation necessary for optimum inventory management is to forecast the final total of booked impressions by each custom demo using pacing history. This is important for maximizing the revenue because inventory needs to be reserved for all the higher value business that is forecast and not sold prematurely to a low CPM buyer. Then the forecast potential inventory (ForeSale) for each custom demo is derived using the custom demo matrix to remove the overlap impressions.

The optimum inventory management approach is to derive the four (4) thresholds from the sold business and to accept or reject impression campaign lines based upon whether they exceed the ForeSale threshold when added to the current sales.

### Target Rate Optimization

The target CPM rates can be adjusted based upon demand to maximize the revenue from the impression inventory. The forecast impressions are derived for each custom demo and compared to the MaxSale potential Impressions. This is targeting all inventory to be sold to the highest CPM custom demo possible. If any demo has the forecast exceeding the potential will have the CPM adjusted up while forecasts falling short of the potential can have the rate adjusted lower (generally below the next lower rank demo) to attract more business if it is in the market. Note that modification of the CPM will necessitate a recalculation of the rank and the inventory thresholds.

### Targeted Custom Demo Impressions (TCI Type)

It is assumed that inventory would be separately allocated for targeted delivery, therefore the calculated impressions below are separate to the broadcast inventory calculations (BCI).

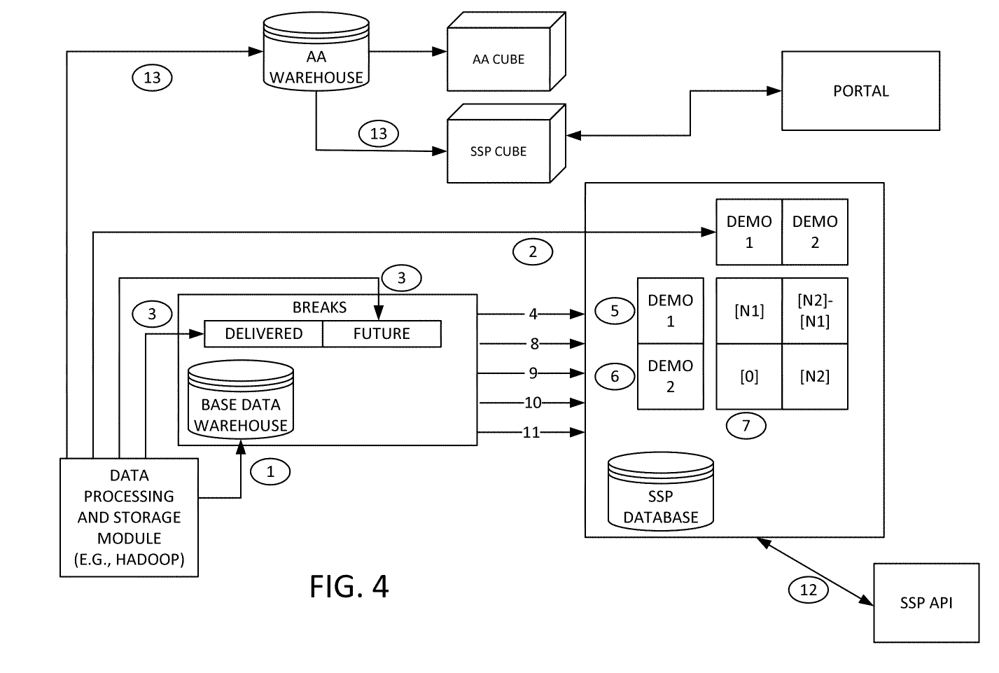

One particular example of a system for programmatic selling of Target Custom Demo Impressions is shown in FIG. 4. In this particular implementation, the components of programmatic selling for Target Custom Demo Impressions are the following:
1. Calculate the Custom Audience per quarter hour interval from the Subscriber Attributes and the channel tune events.
2. Calculate the Custom Audience Matrix per Sales Unit from the Subscriber Attributes and the channel tune events.
3. Load Custom Audience on Breaks (for future Sales Units).
4. Load the SSP database with the Sales Units, the NoSale Projected Impressions, and the CPM Ranking for every demo.
5. Use the Custom Matrix and the ranking to derive the MaxSale Potential Impressions for each Sales Unit demo.
6. Analyze and save the initial Max Value Rate per Sales Unit using market CPM on dominant demos.
7. Derive the initial CPM for every Sales Unit demo and update the SSP database
8. Forecast paced demo orders to modify CPM for the MaxRev VCPM and update the SSP database.
9. Use the Sold impressions and the Demo Matrix to update the CurSale Impressions Sold on the SSP database.
10. Use the Forecast sold impressions and the Demo Matrix to update the ForeSale Impressions Sold.
11. Set the Saleable Flag based upon the Impression thresholds.
12. Validate incoming Target booking requests against the SSP database.
13. Calculate and load the delivered impressions for each of the campaign lines for the target demo.

### A. Example Linear SSP API Transactions for a Linear Programmatic Sale and Purchase System

### Agencies:

This Service supplies the Agency codes and names authorized for the calling Identity. A valid code from this list may be used in the trading parameters.

Parameters: None

Response:

TABLE A-1

| Column | Type | Format | Description |
|---|---|---|---|
| AgencyCode | Varchar(8) | | The SSP code for this approved |
| | | | trading partner |
| AgencyName | Varchar(40) | | The SSP name of the approved |
| | | | trading partner |

### Networks:

This call from the DSP requests the Network Codes and examples of descriptions that may be supported are the following.

Parameters: None

Response:

TABLE A-2

| | | | |
|---|---|---|---|
| Column | Type | Format | Description |

| | | |
|---|---|---|
| NetworkCode | Varchar(6) | The SSP code for the Network |
| NetworkName | Varchar(40) | The SSP name of the Network |

### Spot Lengths:

This call from the DSP requests supported Spot Lengths and a rate multiplier.

Parameters: None

Response:

TABLE A-3

| Column | Type | Format | Description |
|---|---|---|---|
| SpotLength | Int | SSS | The supported Spot Length |
| RateMultiplier | Decimal(6,4) | | The rate multiplier compared |
| | | | to a 30 second length |

### SysCodes:

This transaction from the DSP requests the SysCodes and descriptions supported by the Seller.

Parameters: None

Response:

TABLE A-4

| Column | Type | Format | Description |
|---|---|---|---|
| SysCode | Char(4) | 4 digit string | The SysCode offered |
| SysCodeName | Varchar(40) | | The name of the SysCode |

### Demos:

This transaction from the DSP requests the list of Demographic codes supported together with the Demographic description and the Source of the audience metrics for invoicing.

Parameters: None

Response:

TABLE A-5

| | | | |
|---|---|---|---|
| Column | Type | Format | Description |

| | | |
|---|---|---|
| DemoCode | Varchar(12) | The code of the Demographic |
| | | offered |
| DemoName | Varchar(40) | The name of the Demo |
| DemoSource | Varchar(8) | The source of the average audience |
| | | for this demo. Supported values |
| | | are: |
| | | Nielsen - Nielsen Market audience |
| | | with the Cable Model for SysCode |
| | | audience. |
| | | STB - Direct counting of STB |
| | | impressions filtered by defined |
| | | Household attributes |

### Campaign:

This transaction sets up the agency Campaign parameters for subsequent transactions. It can be used to update the parameters of an existing campaign.

Parameters:

TABLE A-6

| Column | Type | Format | Description |
|---|---|---|---|
| AgencyCode | Varchar(8) | | The SSP code of the |
| | | | approved agency |
| CampaignId | Varchar(12) | | The DSP Campaign |
| | | | Id - unique within |
| | | | the Agency |
| CampaignName | Varchar(40) | | The DSP Name of |
| | | | the Campaign |
| AdvertiserName | Varchar(40) | | The DSP name of |
| | | | the Advertiser |
| Cam- | Int | YYYYMMDD | This is a Monday |
| paignStartDate | | | date of the Start |
| | | | week of the |
| | | | campaign |
| Cam- | Int | YYYYMMDD | This is the Sunday |
| paignEndDate | | | date of the End week |
| | | | of the campaign |
| TargetDemoCode | Varchar(12) | | |
| ContractType | | | |

Response:

TABLE A-7

| | | | |
|---|---|---|---|
| Column | Type | Format | Description |

| | | |
|---|---|---|
| TxStatus | SmallInt | The Success Status of the |
| | | transaction. |
| | | 0 - Success |
| | | 1 - Error |
| ErrorCode | Varchar(6) | The Error Number - 000000 for |
| | | Success |
| ErrorDesc | Varchar(40) | The description of the error |

### Offer:

This transaction from the buyer (DSP) requests an Offer for a Schedule (Week, SysCode, SpotLength) of a Campaign.

An Offer Request has the following fields:

Parameters:

TABLE A-8

| Column | Type | Format | Description |
|---|---|---|---|
| AgencyCode | Varchar(8) | | The SSP code of the approved |
| | | | agency |
| CampaignId | Varchar(12) | | The DSP Campaign Id - |
| | | | unique within the Agency |
| OfferWeek | Int | YYYYWW | The Broadcast week for the |
| | | | Offer |
| SysCode | Char(4) | | The Syscode for the Offer |
| ImpGoal | Int | | The target audience impres- |
| | | | sion goal for the Offer |
| ImpMax | Int | | This is the maximum |
| | | | impressions that could |
| | | | be delivered by the Sales |
| | | | Units included in the Offer. |

Response: Header

TABLE A-9

| | | | |
|---|---|---|---|
| Column | Type | Format | Description |

| | | |
|---|---|---|
| TxStatus | SmallInt | The Success Status of the |
| | | transaction. |
| | | 0 - Success |
| | | 1 - Error |
| ErrorCode | Varchar(6) | The Error Number - 000000 for |
| | | Success |
| ErrorDesc | Varchar(40) | The description of the error |

Example details of an Offer are the following:

TABLE A-10

| Column | Type | Format | Description |
|---|---|---|---|
| SalesUnitId | Varchar(12) | NetworkCode/ | This is a concatenation of the |
| | | DOWCode/Daypart | NetworkCode, the day pattern and the |
| | | | daypart code. Note that the SysCode and |
| | | | the Date are specified to identify a single |
| | | | Sales Unit Instance |
| SalesUnitName | Varchar(40) | | Sales Unit Name |
| TxDate | Int | YYYYMMDD | The date of the start of the Sales Unit |
| NetworkCode | Varchar(6) | | The code for the Network |
| StartTime | Int | HHMM | The start of the time period |
| EndTime | Int | HHMM | The End of the Time Range |
| DOWPattern | Char(7) | YYYYYNN | This indicates the days of the week for this |
| | | | Sales Unit with a Monday week start |
| Priority | SmallInt | | This is a integer where 0 is the highest |
| | | | priority |
| SURateEqu30 | Decimal(12 2) | | This is the Gross rate for the Sales Unit for |
| | | | a 30 second spot |
| SUAvgAud | Decimal(8,2) | | This is the average audience for the Sales |
| | | | Unit in impressions |
| CPMEqu30s | Decimal(10,4) | | This is the CPM of this Sales Unit for the |
| | | | target audience (based upon the Equ30 rate.) |
| SUMaxEqu30s | Decimal(12,2) | | This is the maximum amount of inventory |
| | | | for Sales for each Sales Unit. |
| NumEqu30s | Decimal(12,2) | | This is the number of units needed to reach |
| | | | the requested impression goal |

In this example, the lines are ranked from the smallest CPM to the largest and only Saleable items are included in the offer. The number of Sales Units provided would give the ImpMax quantity of impressions. The NumEqu30s is set to be the SUMaxEqu30s until the impression goal (ImpGoal) is achieved and then it is zero.

### Booking:

A request for a booking comes from a DSP based upon the data in the Offer. Each message only books one schedule within the Campaign. A schedule consists of one week and one SysCode together with a spot length. The header for the booking of the schedule consists of the following:

Parameters:

TABLE A-11

| Column | Type | Format | Description |
|---|---|---|---|
| AgencyCode | Varchar(8) | | The SSP code of the |
| | | | approved agency |
| CampaignId | Varchar(12) | | The DSP Campaign |
| | | | Id - unique within |
| | | | the Agency |
| BookingWeek | Int | YYYYWW | The Broadcast week |
| | | | for this Booking |
| SysCode | Char(4) | | The Syscode for |
| | | | this booking |
| SpotLength | smallint | SSS | The length of the spots |
| TotalGrossCost | Deci- | | The total of the actual |
| | mal(12,2) | | cost of this Schedule |
| | | | using the Spot Length |
| | | | Rate Multiplier |
| TotalImpEqu30s | Deci- | | The total of the |
| | mal(12,2) | | impressions of this |
| | | | Schedule scaled using |
| | | | the Spot Length Rate |
| | | | Multiplier |
| TotalCPMEqu30s | Deci- | | This is the CPM of total |
| | mal(6,2) | | cost divided by total |
| | | | scaled impressions |

Example Booking details are the following:

TABLE A-12

| Column | Type | Format | Description |
|---|---|---|---|
| LineId | Int | | This is the DSP created line of the booking |
| SalesUnitId | Varchar(12) | NetworkCode/ | This is the SSP Sales Unit Code |
| | | DOWCode/Daypart | |
| SalesUnitName | Varchar(40) | | Sales Unit Name |
| TxDate | Int | YYYYMMDD | The date of the start of the Sales Unit |
| NetworkCode | Varchar(6) | | The code for the Network |
| StartTime | Int | HHMM | The start of the time period |
| EndTime | Int | HHMM | The End of the Time Range |
| DOWPattern | Char(7) | YYYYYNN | This indicates the days of the week for this |
| | | | Sales Unit with a Monday week start |
| Priority | SmallInt | | This is a integer where 0 is the highest |
| | | | priority |
| SURate | Decimal(12,2) | | This is the Gross rate for each spot of the |
| | | | Sales Unit for the booked Spot Length |
| SUAvgAud | Decimal(8,2) | | This is the average audience impressions |
| | | | for the Sales Unit scaled by the Spot |
| | | | Length Rate Multiplier |
| CPMEqu30s | Decimal(10,4) | | This is the CPM of this Sales Unit for the |
| | | | target audience being the actual unit rate |
| | | | divided by the scaled audience impressions |
| NumUnits | Int | | This is the number of units booked for this |
| | | | Sales Unit |

Response:

TABLE A-13

| | | | |
|---|---|---|---|
| Column | Type | Format | Description |

| | | |
|---|---|---|
| LineId | int | The Line number with an error - 0 |
| | | for the header errors |
| TxStatus | SmallInt | The Success Status of the transaction. |
| | | 0 - Success |
| | | 1 - Error |
| ErrorCode | Varchar(6) | The Error Number - 000000 for |
| | | Success |
| ErrorDesc | Varchar(40) | The description of the error |

Note that, in this example, the booking can drop lines from the offer by setting the Units to be zero and also change the number of units on any line. New line numbers will be added to the campaign. Existing line numbers will have their data updated. No lines will ever be deleted but the number of units can be set to zero.

### Campaign Summary:

This requests the summary of all the schedules for one Campaign.

Parameters:

TABLE A-14

| | | | |
|---|---|---|---|
| Column | Type | Format | Description |

| | | |
|---|---|---|
| AgencyCode | Varchar(8) | The SSP code of the approved |
| | | agency |
| CampaignId | Varchar(12) | The DSP Campaign Id - unique |
| | | within the Agency |

Response: Header

TABLE A-15

| | | | |
|---|---|---|---|
| Column | Type | Format | Description |

| | | |
|---|---|---|
| TxStatus | SmallInt | The Success Status of the transaction. |
| | | 0 - Success |
| | | 1 - Error |
| ErrorCode | Varchar(6) | The Error Number - 000000 for |
| | | Success |
| ErrorDesc | Varchar(40) | The description of the error |

Examples of current details of Campaign Schedules are the following:

TABLE A-16

| Column | Type | Format | Description |
|---|---|---|---|
| AgencyCode | Varchar(8) | | The SSP code of the |
| | | | approved agency |
| CampaignId | Varchar(12) | | The DSP Campaign |
| | | | Id - unique within |
| | | | the Agency |
| BookingWeek | Int | YYYYWW | The Broadcast week |
| | | | for this Booking |
| SysCode | Char(4) | | The Syscode for |
| | | | this booking |
| SpotLength | smallint | SSS | The length of the spots |
| TotalGrossCost | Deci- | | The total of the actual |
| | mal(12,2) | | cost of this Schedule |
| | | | using the Spot Length |
| | | | Rate Multiplier |
| TotalImpEqu30s | Deci- | | The total of the impres- |
| | mal(12,2) | | sions of this Schedule |
| | | | scaled using the Spot |
| | | | Length Rate Multiplier |
| TotalCPMEqu30s | Deci- | | This is the CPM of total |
| | mal(6,2) | | cost divided by total |
| | | | scaled impressions |

### Campaign Schedule:

The DSP can request the current Booked status of any schedule of a campaign at any time.

Parameters:

TABLE A-17

| Column | Type | Format | Description |
|---|---|---|---|
| AgencyCode | Varchar(8) | | The SSP code of the |
| | | | approved agency |
| CampaignId | Varchar(12) | | The DSP Campaign Id - |
| | | | unique within the Agency |
| BookingWeek | Int | YYYYWW | The Broadcast week |
| | | | for this Booking |
| SysCode | Char(4) | | The Syscode for this |
| | | | booking |
| SpotLength | smallint | SSS | The length of the spots |

Response: Header

TABLE A-18

| Column | Type | Format | Description |
|---|---|---|---|
| TxStatus | SmallInt | | The Success Status of the transaction. |
| | | | 0—Success |
| | | | 1—Error |
| ErrorCode | Varchar(6) | | The Error Number - 000000 for |
| | | | Success |
| ErrorDesc | Varchar(40) | | The description of the error |

TABLE A-19

| Column | Type | Format | Description |
|---|---|---|---|
| AgencyCode | Varchar(8) | | The SSP code of the approved agency |
| CampaignId | Varchar(12) | | The DSP Campaign Id - unique within the |
| | | | Agency |
| BookingWeek | Int | YYYYWW | The Broadcast week for this Booking |
| SysCode | Char(4) | | The Syscode for this booking |
| SpotLength | smallint | SSS | The length of the spots |
| TotalGrossCost | Decimal(12, 2) | | The total of the actual cost of this Schedule |
| | | | using the Spot Length Rate Multiplier |
| TotalImpEqu30s | Decimal(12, 2) | | The total of the impressions of this Schedule |
| | | | scaled using the Spot Length Rate Multiplier |
| TotalCPMEqu30s | Decimal(6, 2) | | This is the CPM of total cost divided by total |
| | | | scaled impressions |

Example details of a Booking for this Schedule are the following:

TABLE A-20

| Column | Type | Format | Description |
|---|---|---|---|
| LineId | Int | | This is the DSP created line of the booking |
| SalesUnitId | Varchar(12) | NetworkCode/ | This is the SSP Sales Unit Code |
| | | DOWCode/Daypart | |
| SalesUnitName | Varchar(40) | | Sales Unit Name |
| TxDate | Int | YYYYMMDD | The date of the start of the Sales Unit |
| NetworkCode | Varchar(6) | | The code for the Network |
| StartTime | Int | HHMM | The start of the time period |
| EndTime | Int | HHMM | The End of the Time Range |
| DOWPattern | Char(7) | YYYYYNN | This indicates the days of the week for this |
| | | | Sales Unit with a Monday week start |
| Priority | SmallInt | | This is a integer where 0 is the highest |
| | | | priority |
| SURate | Decimal(12, 2) | | This is the Gross rate for each spot of the |
| | | | Sales Unit for the booked Spot Length |
| SUAvgAud | Decimal(8, 2) | | This is the average audience impressions |
| | | | for the Sales Unit scaled by the Spot |
| | | | Length Rate Multiplier |
| CPMEqu30s | Decimal(10, 4) | | This is the CPM of this Sales Unit for the |
| | | | target audience being the actual unit rate |
| | | | divided by the scaled audience impressions |
| NumUnits | Int | | This is the number of units booked for this |
| | | | Sales Unit |

### B. Example Campaign Performance Module Definition for an Example Content Inventory Sale and Purchase System

### Overview:

An example Campaign Performance Module includes a set of data warehouse and Business Intelligence components to form a fully operation system dedicated to the powerful analysis of the audience delivery attributes of the transmitted spots and breaks. In some implementations, it requires a Media Base MSO Module to be installed in the data warehouse as a prerequisite. This template covers a number of components:
Data Warehouse Star Schema
Staging schema
ETL Packages
OLAP Structures
Analysis and Portal starter set.

### Data Sources Supported:

In this example, this module is designed to receive all the audience survey books both from the original survey source as well as all the projection books created for analysis:
The latest survey dimensions—Demographics, Demo Maps, Markets, Market Channels, Survey Headers, Survey Programs
The details for the new surveys—Universe Lines and Data, Survey Lines and Data, Survey HUT Lines and Data
The spot assignment instruction maps—Survey Maps

The latest dimensions may be provided to synchronize any new data or changes into the data warehouse. New Survey data will add all new records and replace any existing records of survey data. The Survey Maps define the use of different surveys for both the future projections as well as for past actual periods. Each Campaign can define a different policy of spot assignment through the specification of the Spot Map Id on the supplied contract header. The survey data supplied depends on Channel codes being already supplied by the Media Base Template. Also the supplied Survey Programs support the mapping to the program codes of the Media Base template.

### ETL Specification:

Overview:

Audience data is grouped into sets called books that are received and processed as a unit. After a new book of survey data is loaded into the data warehouse, it is then applied where appropriate to both the spots and the breaks.

A Book can cover one day or a week of survey days. When new data is loaded for a Survey Book, and the new Survey Map records are loaded, then the Assignment ETL process automatically occurs. The Survey Map records have their assignment status cleared by the new survey data and the new map instructions. Using the Survey Map Id and the three (3) target demographs for the contract header, all affected spots in the Spot Fact table are updated with the appropriate new projected or actual audience delivery.

The same application of the new audience books occurs for the break records. This uses a Standard Corporate Survey Map and applies all new book lines to the appropriate break records. All demographics are thus held for every break for analysis.

Another data processing performed by the loading of new or changed spots is that their appropriate audience is also assigned as they are added to the data warehouse. This results in the projected or actual audience being a supported fact measure for all spot based analysis. The same process is applied to all new break records where the new survey line of data is applied to all new break records (whether from a new break or a changed break).

### Book Loading:

This is the process of reading any new books and loading them into the data warehouse. A book has audience for a period of dates, a number of markets, a number of stations in each market, and a number of demographs. The books can be found in either a source database or staging database.

The first step is to compare the list of books in the Source database to the list in the data warehouse and to create Survey Book headers (SurveyHeaders) for all books not yet in the DW. They are flagged as not loaded yet.

The second step is to identify all the markets and the applicable periods where the new books have survey data. Books can hold one market or many and can contain one date or many. However, a book will be processed as a unit and thus any book updates or additions are created in the source system as a new Survey Book to trigger the new loading. All the markets and periods where the book applies are loaded into the Survey mapping table (SurveyMaps) from the data in the source system.

### Survey Maps:

A survey Map is applicable to both past survey application and to projected audience delivery.

For past survey data, it is assumed to map to the transmissions dates that were surveyed. Where the book is a sweep, then it can also be defined to apply to intervening dates between sweeps.

It is also possible to define that a past survey is applicable to forecast the audience for some or all future dates in the Survey map table. Normally, an additional forecast survey book is created by research as a projection from past actual books and this additional book is put into the source survey database. The future periods when this projected book applies are also specified in the source survey database and then these records are loaded into the Survey Map table.

The survey map table specifies for each market, for each non-overlapping date period, the survey book that is applicable. It also has the detailed flags to control whether the breaks and the spots have had this survey book applied.

### Detailed Loading:

After the new books that have not been loaded are identified, the process will copy the full survey details over to the data warehouse. This includes the Universe numbers and the HUT (Homes Using Television) for all the Base demographs.

### Audience Application:

After a new book of audience data is identified and loaded into the data warehouse, the Survey Map records that are applicable are flagged to indicate that Markets and date periods need the new survey data applied.

The Apply Survey task will work through this list of markets and dates and apply the appropriate audience to both the spots and the breaks affected.

### Spot Apply:

Spots belong to Contracts which specify a Primary, Secondary and Corporate demograph as the target audience for that campaign. The corporate demograph is selected by the media corporation as the common demograph for cross campaign analysis so it is always the same for every contract. Spots do have the three audience values proposed on them from the loading of the spots from traffic. They have three additional columns to hold the updated projected audience which can be applied multiple times until the final delivered audience is applied.

The application process works on each survey map record at a time and finds all spots affected in the applicable market and date period and applies the audience from the survey book. Note that both calculated demographs and base demographs can be used as contract target demographs.

The application process creates reversal records in the Survey Audit table for all of the applicable spots with the old audience. It then updates the Spot Fact record with the new audience. It then extracts these spots again to the Survey Audit table with the new audience. These Survey Audit records are accumulated for subsequent cube increments. Note that this update process of the data warehouse fact records does not generate additional spot fact records and also does not support reporting over these changes of projected spot audience.

There can be multiple Survey Map Ids, each defining a different set of books that apply to spots. This is to support the special instructions from agencies to apply special processing to the Nielsen books before application and also to use special projection formulae for the projected audience for their spots. Thus the Survey Map Id is defined on the Contract header and is used to filter only the spots applicable for this entry in the Survey Map table. Note that this is for special calculation support and normally most contracts will default to the standard corporate Survey Map Id which is the same Survey Map used to apply audience to all breaks.

When the spots have the new survey map entry applied, then a flag indicates that this step is complete and another Survey Map record is found for updating.

Note that existing spots need to be updated with audience when a new book is supplied. However, new audience needs to be looked up if any attribute of a spot (such as time of transmission) is changed. So the normal data warehouse spot change and insertion processes have a special step to lookup the audience on all new spots and changed spots.

### Break Apply:

Survey books share a survey line table for the audience information with globally unique survey line identifiers. Breaks need all possible demographs available and thus it is the Survey Line Id that is held on the break records to refer to all the audience information that is applicable for the break record.

In the same process that found a Survey Map Entry to apply, the Survey Map Id is checked to only apply audience to breaks from within one Corporate Survey Map. Thus only the Survey Map Entries within the Corporate Standard Survey Map will be used to apply audience to breaks.

Again, the process selects the breaks within the date period and market from the Survey Map Entry and creates the Survey Audit reversal records. Then the Break Fact Records are updated with the new Survey Line Id. The applicable breaks are re-extracted to the Survey Audit table with the new Survey Line Id. These audit records are accumulated for a subsequent application to increment the cube. Note that this update process of the data warehouse fact records does not generate additional break fact records and also does not support reporting over these changes of projected break audience.

Note also that the normal data warehouse changes to breaks with insert and changes especially to the time of the break require a lookup of the applicable audience as part of normal loading. It is not used to detect which records have been changed but only to always use the latest survey application for any new or changed break records.

The Survey Map Entry is updated to record the completion of break application.

### Cube Updates:

After the process finishes application for each Survey Map entry, then a check is made to see if no more applications are required. If this is true, then the process uses the specially created Survey Audit tables for spots and breaks to increment the cubes to change to the new audience values.

Note that a full cube rebuild will also use the new survey audience values for the cube results.

### Summary

The process of keeping a data warehouse up to date with applicable survey results has a process related to new books as well as a lookup for new and changed spot and break records in the data warehouse. The process records the updates so that cube totals can be automatically incremented with the new results.

### Facts and Dimensions Supported:

The dimensions supported in the data warehouse star schemas have a corresponding dimension in the OLAP analysis together with the hierarchies, levels, and attributes or that dimension. Most Fact tables of the data warehouse star schemas have a corresponding Measure Group in the OLAP analysis.

The additional Fact table is the following:

Survey Audience

The raw measures of the Survey Audience Fact are the following:
Audience DMA
Audience NSI

New dimensions supported for the Survey Audience include the following:
Survey Book
Survey Map
Market
Channel
Transmission Date
Time
Demograph

Additional raw measures supported for the Spot Activity Facts include the following:
Delivered Audience 1
Delivered Audience 2
Delivered Audience Corporate

Analysis dimensions supported for the Spot Activity Facts include the following:
Clients
Agencies
Transmission Dates
Programs
Program Classes
Sources
Revenue Types
Sales Offices
Representatives
Plotted Status
Activity Dates
Break Classes
Contract Classes
Spot Classes
Markets
Invoiced
Material
Products
Durations
Contracts
Channel
Dayparts
Sizes
Copy Group
Headends
Sales Zones
Transmission Time
Sales Units
Priorities

Example dimensions supported for Break Activity Facts include the following:
Transmission Dates
Transmission Times
Activity Dates
Transmitted Programs
Dayparts
Break Classes
Demographs

Example New Measures supported for Break Activity Facts include the following:
Audience
Share

### OLAP Structures:

Each Dimension defined above has Hierarchies, Levels and Attributes configured to provide common presentation and drill structures for media analysis. The Fact measures are complimented by grouped sets of calculated measures. Some calculated measures are presented as normal measures for analysis. For Example:
Delivered audience
Share
Delivery vs. Proposed
Cost per Thousand
Cost Per Rating Point

Other powerful calculated metrics are grouped into their own Dimension Hierarchies for analysis over all other measures. The groups form common sets of calculated Metrics for fast analysis preparation. For example, some calculated metrics are:
Last Month
Last Month Variance %

Examples of Calculated Metric Level groups include the following:
Previous periods
Last Periods

### Analysis Families:

With the integration of all the dimensions in the OLAP structures, every combination of dimensions and Facts is available for fast analysis. The Template does supply a broad set of valuable examples of analysis for the initial installation. The analysis examples are grouped into the following families.

### Survey Analysis:

This report family looks at the summaries of the delivered audience from the survey books. The delivered average audience and shares can be reported on by market, channel, date, time, and program.

### Delivery Analysis:

This report family looks at the applied audience for all breaks both past and projected for all demographs. This allows analysis for all dimensions of the Break Activity such as Channel, Transmission Date, Time, Program, Dayparts, Break type, Program Class. The measures can be share and audience together with Conversion Efficiency. Note that audience based forecasts are included based upon unsold Impressions and Cost per thousand for the corporate demograph.

### Campaign Performance Analysis:

These web analysis views present the data warehouse information for the campaigns over all channels with both delivered audience compared with proposed audience for campaigns. This family allows analysis over the dimensions of campaign, channel, and transmission date.
Includes both Projected and Delivered audience
Comparison of projected delivery to proposed targets
Across the 3 demographics (Primary, Secondary, Corporate)
CPT or Impressions comparison
Drill by Demo, Agency, Advertiser, Campaign, Date

### Calculated Measures:

Demos available:—Primary, Secondary, Corporate

Equivalized Impressions:—Spot length scaled to 30s

Impressions or Rating Points

Totaled or Average per Spot

Proposed or Actual

Difference between Actual and Proposed

Cost per Thousand Proposed and Delivered

### Dimensions:

Order Target Demograph

Agency

Advertiser

Broadcast Period

### Impression Capacity Analysis:

Impression Capacity Analysis by demo totals the impression capacity on each break.

For a corporate demo, an Impression Capacity can have the Sold impressions subtracted to show the Impression Avails by percentage.

The sold revenue and sold impressions calculates the actual Cost per Thousand

Using the Impressions Avails and the Actual CPT for the corporate demo, the Forecast potential Revenue can be generated.

### Measures Used:

Conversion Ratio—of the demo impressions compared to the Corporate Demo

Conversion Ratio Overall—for the whole day

Conversion Efficiency—the ratio of the Conversion Ratios.

### Dimensions Used:

Dayparts

Programs

Times

### Valuation Analysis:

Value Analysis uses as input a set of market researched CPT's by demo.

The maximum value that would be paid for each program is calculated over all the demos.

The historic ratio of the actual rates paid for a program to the Maximum CPT Value.

This is used to adjust the projected Maximum CPT Value to generate a Forecast Value for the Program.

This is used to set the initial rate and is used to calculate the VPT for the program for optimum campaign generation.

### Measures Used:

CPT Value—Input Market CPT applied to each Program for each Demo
Maximum CPT Value—The maximum of the CPT Values over all the demographics
Rate Multiplier—The ratio of the actual average rate paid for a program to the Maximum CPT Value
Rate Multiplier Last Quarter—The Rate Multiplier for the program over the last quarter
Value Forecast—The current maximum CPT value times the Historic Rate Multiplier for the Program
Forecast VPT—The Value Forecast over the impressions projected for the program for each demo

### Sensitivity (Elasticity) Analysis:

Price Sensitivity Analysis is to measure from past sales the sensitivity to price changes for each primary demo of campaigns
The price is the CPT paid for the spot
The sold quantity is the number of seconds sold at this value CPT
The scaled sensitivity is such that a sensitivity of −1 indicates that a 1% increase in CPT price causes a drop of 1% in the amount of sold seconds for this target demo group of campaign buyers

### Measures Used:

Price Sensitivity Local—is the scaled slope of the Price/Demand relationship
Price Sensitivity Actual CPT—this is the scaled Price Sensitivity at the current level of the actual CPT for each Order Target Primary Demo
Price Sensitivity Last Quarter—This is the price sensitivity overall for the last quarter for each order target primary demo

### C. Example Targeted SSP Module Functional Definition and Targeted SSP API Transactions

In one implementation, a targeted delivery campaign allows many different targeted spots to be delivered into a single advertising slot. In this implementation, two goals may be shared with a broadcast delivery:
1. Never contract for more targeted impressions than will occur.
2. Contract each CPM at the highest level that will sell the impression inventory (maximize the revenue).

### Agencies:

In this example, a service supplies Agency codes and names authorized for a calling Identity. A valid code from this list is be used in the trading parameters.

Parameters: None

Response:

TABLE C-1

| Column | Type | Format | Description |
|---|---|---|---|
| AgencyCode | Varchar(8) | | The SSP code for this approved |
| | | | trading partner |
| AgencyName | Varchar(40) | | The SSP name of the approved |
| | | | trading partner |

### Networks:

This call from the DSP requests the Network Codes and descriptions that are supported.

Parameters: None

Response:

TABLE C-2

| Column | Type | Format | Description |
|---|---|---|---|
| NetworkCode | Varchar(6) | | The SSP code for the Network |
| NetworkName | Varchar(40) | | The SSP name of the Network |

### Inventory Sets:

This call from the DSP requests the Network Codes and descriptions that are supported.

Parameters: None

Response:

TABLE C-3

| Column | Type | Format | Description |
|---|---|---|---|
| InventorySetCode | Varchar(8) | | The SSP code for the |
| | | | Inventory Set |
| InventorySetName | Varchar(40) | | The SSP name of |
| | | | the Inventory Set |
| SysCode | Char(4) | | The Syscode of |
| | | | the Inventory Set |

### Spot Lengths:

This call from the DSP requests Spot Lengths supported and a rate multiplier.

Parameters: None

Response:

TABLE C-4

| Column | Type | Format | Description |
|---|---|---|---|
| SpotLength | Int | SSS | The supported Spot Length |
| RateMultiplier | Decimal(6, 4) | | The rate multiplier compared to |
| | | | a 30 second length |
| LinearFlag | Char(1) | Y/N | Supports linear delivery |
| TargetedFlag | Char(1) | Y/N | Supports Targeted delivery |

### SysCodes:

This transaction from the DSP requests SysCodes and descriptions that are supported by the Seller.

Parameters: None

Response:

TABLE C-5

| Column | Type | Format | Description |
|---|---|---|---|
| SysCode | Char(4) | 4 digit string | The SysCode offered |
| SysCodeName | Varchar(40) | | The name of the SysCode |

### Demos:

This transaction from the DSP requests a list of Demographic codes supported together with a Demographic description and a Source of the audience metrics for invoicing.

Parameters: None

Response:

TABLE C-6

| Column | Type | Format | Description |
|---|---|---|---|
| DemoCode | Varchar(12) | | The code of the Demographic |
| | | | offered |
| DemoName | Varchar(40) | | The name of the Demo |
| DemoSource | Varchar(8) | | The source of the average |
| | | | audience for this demo. |
| | | | Supported values are: |
| | | | Nielsen - Nielsen Market audience |
| | | | with the Cable Model for |
| | | | SysCode audience. |
| | | | STB - Direct counting |
| | | | of STB impressions |
| | | | filtered by defined |
| | | | Household attributes |
| LinearFlag | Char(1) | Y/N | Supports linear delivery |
| TargetedFlag | Char(1) | Y/N | Supports Targeted delivery |

### Campaign:

This transaction sets up the agency Campaign parameters for subsequent transactions. It can be used to update the parameters of an existing campaign.

Parameters:

TABLE C-7

| Column | Type | Format | Description |
|---|---|---|---|
| AgencyCode | Varchar(8) | | The SSP code of the |
| | | | approved agency |
| CampaignId | Varchar(12) | | The DSP |
| | | | Campaign Id - |
| | | | unique within |
| | | | the Agency |
| CampaignName | Varchar(40) | | The DSP Name |
| | | | of the Campaign |
| AdvertiserName | Varchar(40) | | The DSP name of |
| | | | the Advertiser |
| CampaignStartDate | Int | YYYYMMDD | This is a Monday |
| | | | date of the |
| | | | Start week of |
| | | | the campaign |
| CampaignEndDate | Int | YYYYMMDD | This is the Sunday |
| | | | date of the |
| | | | End week of |
| | | | the campaign |
| TargetDemoCode | Varchar(12) | | The |
| ContractType | Varchar(4) | | |
| TarDeliveryFlag | Char(1) | | This campaign |
| | | | will be delivered |
| | | | by targeted ads. |

Response:

TABLE C-8

| Column | Type | Format | Description |
|---|---|---|---|
| TxStatus | SmallInt | | The Success Status of the transaction. |
| | | | 0—Success |
| | | | 1—Error |
| ErrorCode | Varchar(6) | | The Error Number - |
| | | | 000000 for Success |
| ErrorDesc | Varchar(40) | | The description of the error |

### Targeted Offer

This transaction from the buyer (DSP) requests an Offer for a Schedule (Week, SysCode, SpotLength) of a Campaign. An Offer request has the following fields:

Parameters:

TABLE C-9

| Column | Type | Format | Description |
|---|---|---|---|
| AgencyCode | Varchar(8) | | The SSP code of the approved |
| | | | agency |
| CampaignId | Varchar(12) | | The DSP Campaign Id - |
| | | | unique within the |
| | | | Agency |
| TargetDemoCode | Varchar(12) | | The target demo requested |

Response: Header

TABLE C-10

| Column | Type | Format | Description |
|---|---|---|---|
| TxStatus | SmallInt | | The Success Status of the transaction. |
| | | | 0—Success |
| | | | 1—Error |
| ErrorCode | Varchar(6) | | The Error Number - |
| | | | 000000 for Success |
| ErrorDesc | Varchar(40) | | The description of the error |

These are example details of an Offer

TABLE C-11

| Column | Type | Format | Description |
|---|---|---|---|
| TxBcastWeek | Int | YYYYWW | The week of the Offer |
| InventorySetCode | Varchar(8) | | The inventory |
| | | | set of the |
| CPM | Decimal(6, 2) | | This is the CPM for |
| | | | this target demo. |
| MaxImps | Decimal(10, 2) | | This is the maximum |
| | | | number of impressions |
| | | | offered for this week |
| | | | and inventory set. |

In this example, only Saleable items are included in the offer.

### Booking:

A request for a booking comes from the DSP based upon the data in the Offer. Each message, in this implementation, only books one schedule within the Campaign. A schedule includes one week and one SysCode together with a spot length.

A header for a booking of a schedule includes:

Parameters:

TABLE C-12

| Column | Type | Format | Description |
|---|---|---|---|
| AgencyCode | Varchar(8) | | The SSP code of the approved agency |
| CampaignId | Varchar(12) | | The DSP Campaign Id - unique within the |
| | | | Agency |
| SpotLength | smallint | SSS | The length of the spots |
| TotalGrossCost | Decimal(12, 2) | | The total of the actual cost of this Schedule |
| | | | using the Spot Length Rate Multiplier |
| TotalImpEqu30s | Decimal(12, 2) | | The total of the impressions of this Schedule |
| | | | scaled using the Spot Length Rate Multiplier |
| TotalCPMEqu30s | Decimal(6, 2) | | This is the CPM of total cost divided by total |
| | | | scaled impressions |

The following are details of an example Booking:

TABLE C-13

| Column | Type | Format | Description |
|---|---|---|---|
| LineId | Int | | This is the DSP created line of the |
| | | | booking |
| TxBcastWeek | Int | YYYYWW | The week of the Offer |
| InventorySetCode | Varchar(8) | | The inventory set of the |
| CPM | Decimal(6, 2) | | This is the CPM for this target demo. |
| GoalImps | Decimal(10, 2) | | This is the maximum number of |
| | | | impressions offered for this week and |
| | | | inventory set. |

Response:

TABLE C-14

| Column | Type | Format | Description |
|---|---|---|---|
| LineId | int | | The Line number with an error - 0 |
| | | | for the header errors |
| TxStatus | SmallInt | | The Success Status of the transaction. |
| | | | 0—Success |
| | | | 1—Error |
| ErrorCode | Varchar(6) | | The Error Number - 000000 for |
| | | | Success |
| ErrorDesc | Varchar(40) | | The description of the error |

Note that, in this example, a booking can drop lines from an offer by setting the Units to be zero and also change the number of units on any line. New line numbers can be added to the campaign. Existing line numbers may have their data updated. In this example, no lines will be deleted but the number of units can be set to zero.

### Campaign Summary:

In this example, a Campaign Summary requests a summary of all schedules for one Campaign.

Parameters:

TABLE C-15

| Column | Type | Format | Description |
|---|---|---|---|
| AgencyCode | Varchar(8) | | The SSP code of the approved |
| | | | agency |
| CampaignId | Varchar(12) | | The DSP Campaign Id - unique |
| | | | within the Agency |

Response: Header

TABLE C-16

| Column | Type | Format | Description |
|---|---|---|---|
| TxStatus | SmallInt | | The Success Status of the transaction. |
| | | | 0—Success |
| | | | 1—Error |
| ErrorCode | Varchar(6) | | The Error Number - 000000 for |
| | | | Success |
| ErrorDesc | Varchar(40) | | The description of the error |

The following are examples of current details of Campaign Schedules:

TABLE C-17

| Column | Type | Format | Description |
|---|---|---|---|
| AgencyCode | Varchar(8) | | The SSP code of the approved agency |
| CampaignId | Varchar(12) | | The DSP Campaign Id - unique within the |
| | | | Agency |
| BookingWeek | Int | YYYYWW | The Broadcast week for this Booking |
| SpotLength | smallint | SSS | The length of the spots |
| TotalGrossCost | Decimal(12, 2) | | The total of the actual cost of this |
| | | | Schedule using the Spot Length Rate |
| | | | Multiplier |
| TotalImpEqu30s | Decimal(12, 2) | | The total of the impressions of this |
| | | | Schedule scaled using the Spot Length |
| | | | Rate Multiplier |
| TotalCPMEqu30s | Decimal(6, 2) | | This is the CPM of total cost divided by |
| | | | total scaled impressions |

### Targeted Campaign Schedule:

A DSP can request a current Booked status of a targeted campaign at any time.

Parameters:

TABLE C-18

| Column | Type | Format | Description |
|---|---|---|---|
| AgencyCode | Varchar(8) | | The SSP code of the approved |
| | | | agency |
| CampaignId | Varchar(12) | | The DSP Campaign Id - unique |
| | | | within the Agency |
| SpotLength | smallint | SSS | The length of the spots |

Response: The following is a header of a response.

TABLE C-19

| Column | Type | Format | Description |
|---|---|---|---|
| TxStatus | SmallInt | | The Success Status of the transaction. |
| | | | 0—Success |
| | | | 1—Error |
| ErrorCode | Varchar(6) | | The Error Number - 000000 for |
| | | | Success |
| ErrorDesc | Varchar(40) | | The description of the error |

TABLE C-20

| Column | Type | Format | Description |
|---|---|---|---|
| AgencyCode | Varchar(8) | | The SSP code of the approved agency |
| CampaignId | Varchar(12) | | The DSP Campaign Id - unique within the |
| | | | Agency |
| BookingWeek | Int | YYYYWW | The Broadcast week for this Booking |
| InventorySetCode | Varchar(8) | | The Inventory Code for this booking |
| SpotLength | smallint | SSS | The length of the spots |
| CPM | Decimal(6, 2) | | This is the CPM |
| GoalImp | Decimal(12, 2) | | The goal of the impressions for this week |
| | | | and inventory set |

### Targeted SSP Schema:

Targeted Inventory can be separated from the broadcast inventory and have its own potential calculations.

Inventory Sets:

An Inventory Set may generally have an associated Syscode for an independent set of carved out inventory.

TABLE C-21

| Column | Type | Format | Description |
|---|---|---|---|
| InventorySetKey | Int | | This is the unique key |
| | | | to the Target Demos |
| | | | Detail table |
| InventorySetCode | Varchar(8) | | This is the code for the |
| | | | inventory set. |
| InventorySetName | Int | YYYYWW | Broadcast week of the |
| | | | Sales Unit Detail |
| Syscode | Char(4) | | The Syscode of the |
| | | | inventory set |

### Spot Lengths:

This table holds example Spot Lengths supported and a rate multiplier.

TABLE C-22

| Column | Type | Format | Description |
|---|---|---|---|
| SpotLength | Int | SSS | The supported Spot Length |
| RateMultiplier | Decimal(6, 4) | | The rate multiplier compared |
| | | | to a 30 second length |
| LinearFlag | Bit | | This indicates if this length is |
| | | | supported for Linear delivery |
| TargetedFlag | Bit | | This indicates if this length is |
| | | | supported for Targeted delivery |

### Demos:

The following table holds a list of Demographic codes supported together with a Demographic description and a Source of the audience metrics for invoicing.

TABLE C-23

| Column | Type | Format | Description |
|---|---|---|---|
| DemoCode | Varchar(12) | | The code of the Demographic |
| | | | offered |
| DemoName | Varchar(40) | | The name of the Demo |
| DemoSource | Varchar(8) | | The source of the average |
| | | | audience for this demo. Supported |
| | | | values are: |
| | | | Nielsen - Nielsen Market audience |
| | | | with the Cable Model for SysCode |
| | | | STB - Direct counting of STB |
| | | | impressions audience. filtered by |
| | | | defined Household attributes |
| LinearFlag | Bit | | This demo is offered for Linear |
| | | | delivery |
| TargetedFlag | Bit | | This demo is offered for Targeted |
| | | | delivery |

### Target Demos Detail:

A Target Demos Detail table may hold each targeted demo's control data for each week.

TABLE C-24

| Column | Type | Format | Description |
|---|---|---|---|
| TargetDemosKey | Int | | This is the unique key to the Target |
| | | | Demos Detail table |
| TxBcastWeek | Int | YYYYWW | Broadcast week of the Sales Unit |
| | | | Detail |
| InventorySetKey | smallInt | | This is the key to the inventory set |
| | | | for this record |
| TargetDemoKey | smallint | | The key to the target demo |
| TotalHours | Numeric(5, 2) | | The total transmission hours covered |
| | | | per week for this Inventory Set |
| DemoRank | smallint | | Rank of the demo within this week |
| | | | and inventory Set |
| LinearCPM | Numeric(6, 2) | | This is the CPM calculated over the |
| | | | linear inventory current Rate for this |
| | | | demo. |
| RateIncrMult | Numeric(6, 2) | | This is the rate increment to apply if |
| | | | the projected inventory is oversold. |
| CurCPM | Numeric(6.2) | | This is the current CPM that will be |
| | | | offered for this demo. |
| ProjMult | Numeric(6, 2) | | This is the projection multiplier based |
| | | | upon historic pacing comparisons. |
| NoSalePotImps | Numeric(10, | | This is the independent Potential |
| | 2) | | Impressions of this demo in this |
| | | | Inventory Set and Week. |
| MaxSalePotImps | Numeric(10, | | This is the potential impression |
| | 2) | | amount for this demo when the |
| | | | overlap of all higher demos are |
| | | | removed assuming they are all fully |
| | | | sold. |
| CurSalePotImps | Numeric(10, | | This is the reduced potential |
| | 2) | | impressions of this demo when all |
| | | | other currently sold demos have their |
| | | | overlap subtracted. |
| ForeSalePotImps | Numeric(10, | | This is the potential impressions for |
| | 2) | | this demo when all the forecast |
| | | | impressions overlap from the higher |
| | | | demos is removed, and the currently |
| | | | sold impression overlap from the |
| | | | lower demos is removed. |
| CurSoldImps | Numeric(6, 2) | | This is the number of impressions |
| | | | sold for this demo, week and |
| | | | inventory set. |
| ForeSoldImps | Numeric(6, 2) | | This is the forecast impressions that |
| | | | will be sold for this demo. |
| SalableFlag | Bit | | This flag is cleared to zero if the |
| | | | demo is sold out or the higher demos |
| | | | will sell it out. |

### Bookings Tables:

A current state of bookings accepted may be held in Campaign details tables.

### Campaign Master Table:

TABLE C-25

| Column | Type | Format | Description |
|---|---|---|---|
| CampaignKey | Int | | This is the key of the campaign |
| | | | master |
| AgencyCode | Varchar(8) | | The SSP code of the approved |
| | | | agency |
| CampaignId | Varchar(12) | | The DSP Campaign Id - unique |
| | | | within the Agency |
| CampaignName | Varchar(40) | | The DSP Name of the Campaign |
| AdvertiserName | Varchar(40) | | The DSP name of the Advertiser |
| CampaignStartDate | Int | YYYYMMDD | This is a Monday date of the Start |
| | | | week of the campaign |
| CampaignEndDate | Int | YYYYMMDD | This is the Sunday date of the End |
| | | | week of the campaign |
| TargetDemoCode | Varchar(12) | | |
| ContractType | Varchar(4) | | The code of the contract type |
| TarDeliveryFlag | Bit | | The booking is for targeted delivery |

### Booking Targets Table:

TABLE C-26

| Column | Type | Format | Description |
|---|---|---|---|
| CampaignKey | Int | | This is the key to the Campaign |
| | | | Header |
| LineId | Int | | This is the DSP created line of the |
| | | | booking within the campaign |
| SpotLength | Int | | This is the spot length for the |
| | | | booking line |
| TxBcastWeek | Int | YYYYWW | The broadcast week for the booking |
| | | | line |
| InventorySetCode | Varchar(8) | | The code for the Inventory Set |
| CPM | Decimal(12, 2) | | This is the CPM for the contract line |
| GoalImps | Decimal(8, 2) | | This is the impression goal for the |
| | | | contract line |

In this particular example a Targeted SSP Module includes the components to use a data warehouse to derive data for a real time Selling Side Platform (SSP) of programmatic buying solution for targeted delivery. It defines a Web Services for selling the inventory as well as a data schema for those Web Services. The Module includes the support for both inventory management and optimum rate calculations for a multichannel video programming distributor (MVPD).

### D. Exemplary Computing System

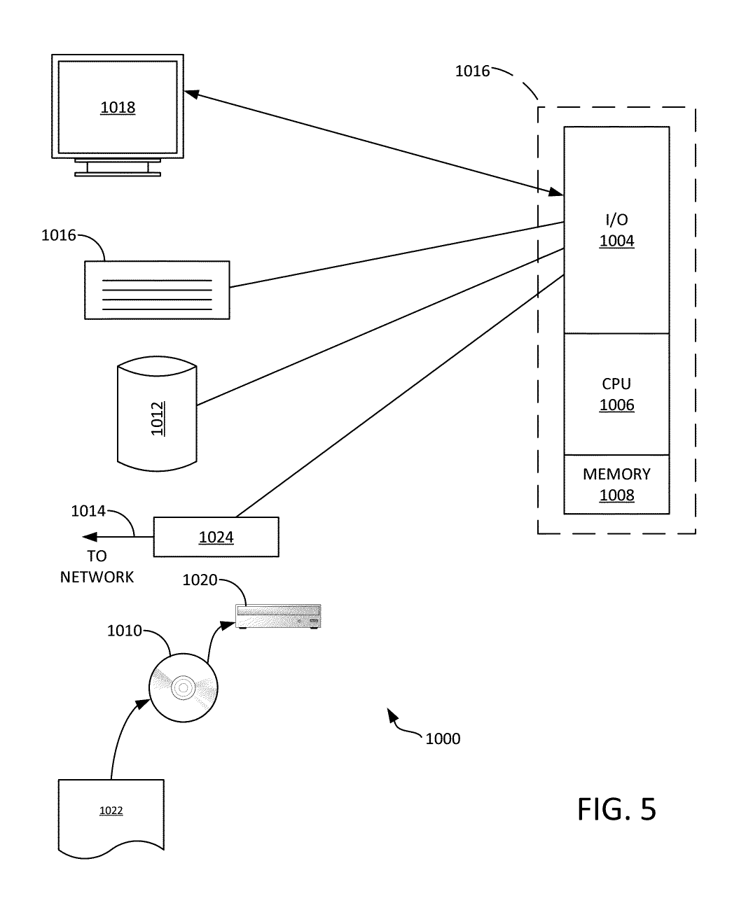

FIG. 5 is a schematic diagram of an example computing device 1000 upon which a programmatic platform and/or database system may be implemented. As discussed herein, implementations include various steps. A variety of these steps may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware.

FIG. 5 illustrates an exemplary system useful in implementations of the described technology. A general purpose computer system 1000 is capable of executing a computer program product to execute a computer process. Data and program files may be input to the computer system 1000, which reads the files and executes the programs therein. Some of the elements of a general purpose computer system 1000 are shown in FIG. 5 wherein a processor 1002 is shown having an input/output (I/O) section 1004, a Central Processing Unit (CPU) 1006, and a memory section 1008. There may be one or more processors 1002, such that the processor 1002 of the computer system 1000 comprises a single central-processing unit 1006, or a plurality of processing units, commonly referred to as a parallel processing environment. The computer system 1000 may be a conventional computer, a distributed computer, or any other type of computer. The described technology is optionally implemented in software devices loaded in memory 1008, stored on a configured DVD/CD-ROM 1010 or storage unit 1012, and/or communicated via a wired or wireless network link 1014 on a carrier signal, thereby transforming the computer system 1000 in FIG. 1 into a special purpose machine for implementing the described operations.

The I/O section 1004 is connected to one or more user-interface devices (e.g., a keyboard 1016 and a display unit 1018), a disk storage unit 1012, and a disk drive unit 1020. Generally, in contemporary systems, the disk drive unit 1020 is a DVD/CD-ROM drive unit capable of reading the DVD/CD-ROM medium 1010, which typically contains programs and data 1022. Computer program products containing mechanisms to effectuate the systems and methods in accordance with the described technology may reside in the memory section 1008, on a disk storage unit 1012, on the DVD/CD-ROM medium 1010 or other non-transitory data storage medium of such a system 1000. Alternatively, a disk drive unit 1020 may be replaced or supplemented by a floppy drive unit, a tape drive unit, or other non-transitory storage medium drive unit. The network adapter 1024 is capable of connecting the computer system to a network via the network link 1014, through which the computer system can receive instructions and data embodied in a carrier wave. Examples of such systems include SPARC systems offered by Sun Microsystems, Inc., personal computers offered by Dell Corporation and by other manufacturers of Intel-compatible personal computers, PowerPC-based computing systems, ARM-based computing systems and other systems running a UNIX-based or other operating system. It should be understood that computing systems may also embody devices such as Personal Digital Assistants (PDAs), mobile phones, gaming consoles, set top boxes, etc.

When used in a LAN-networking environment, the computer system 1000 is connected (by wired connection or wirelessly) to a local network through the network interface or adapter 1024, which is one type of communications device. When used in a WAN-networking environment, the computer system 1000 typically includes a modem, a network adapter, or any other type of communications device for establishing communications over the wide area network. In a networked environment, program modules depicted relative to the computer system 1000 or portions thereof, may be stored in a remote memory storage device. It is appreciated that the network connections shown are exemplary and other means of and communications devices for establishing a communications link between the computers may be used.

In accordance with an implementation, software instructions and data directed toward operating the subsystems may reside on the disk storage unit 1012, disk drive unit 1020 or other non-transitory storage medium units coupled to the computer system. Said software instructions may also be executed by CPU 1006.

The implementations described herein are implemented as logical steps in one or more computer systems. The logical operations are implemented (1) as a sequence of processor-implemented steps executing in one or more computer systems and (2) as interconnected machine or circuit modules within one or more computer systems. The implementation is a matter of choice, dependent on the performance requirements of a particular computer system. Accordingly, the logical operations making up the embodiments and/or implementations described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of exemplary implementations of the invention. Since many implementations of the invention can be made without departing from the spirit and scope of the invention, the invention resides in the claims hereinafter appended. Furthermore, structural features of the different implementations may be combined in yet another implementation without departing from the recited claims.

In some implementations, articles of manufacture are provided as computer program products. One implementation of a computer program product provides a transitory or non-transitory computer program storage medium readable by a computer system and encoding a computer program.

Furthermore, certain operations in the methods described above must naturally precede others for the described method to function as described. However, the described methods are not limited to the order of operations described if such order sequence does not alter the functionality of the method. That is, it is recognized that some operations may be performed before or after other operations without departing from the scope and spirit of the claims.

Although multiple implementations of this invention have been described above with a certain degree of particularity, those skilled in the art could make numerous alterations to the disclosed embodiments without departing from the spirit or scope of this invention. For example, although linear or targeted campaigns may be shown in various implementations, other implementations may include targeted or linear campaigns, respectively, or a combination of linear and targeted campaigns. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A programmatic platform of a computer system for facilitating the selling and buying of content inventory for advertising, the platform comprising:
a sell-side interface comprising a processor configured to communicate with a sell-side platform;
a buy-side interface comprising a processor configured to communication with a buy-side platform;
a protocol comprising pre-defined data structures configured for facilitating the transmission of sell offers sent from the sell-side platform to the buy-side platform, wherein the offers comprise a list of saleable sales units with their rate available for purchase from the sell-side platform configured according to the pre-defined protocol, and for facilitating the transmission of bookings from the buy-side platform to the sell-side platform via the buy-side interface to the sell-side interface, wherein the bookings comprise a confirmation of at least one of the list of offered sale units.

2. The platform of claim 1 wherein the protocol is further configured to facilitate the requested transmission of the agencies supported by this secured session from the sell-side platform to the buy-side platform.

3. The platform of claim 1 wherein the protocol is further configured to facilitate the requested transmission of the network codes supported by this SSP Platform from the sell-side platform to the buy-side platform.

4. The platform of claim 1 wherein the protocol is further configured to facilitate the requested transmission of the advertising spot lengths supported by the SSP platform from the sell-side platform to the buy-side platform

5. The platform of claim 1 wherein the protocol is further configured to facilitate the requested transmission of the delivery Syscodes supported by the SSP platform from the sell-side platform to the buy-side platform

6. The platform of claim 1 wherein the protocol is further configured to facilitate the requested transmission of the Demographic categories supported by the SSP platform from the sell-side platform to the buy-side platform

7. The platform of claim 1 wherein the protocol is further configured to facilitate the transmission of the attributes of a Campaign Header to be used by the DSP Platform from the buy-side platform to the sell-side platform

8. The platform of claim 1 wherein the protocol is further configured to facilitate the transmission of at least one offer request received from the buy-side platform to the sell-side platform.

9. The platform of claim 8 wherein the offer request specifies the agency, the campaign, the week, the target demographic, and the SysCode requested.

10. The platform of claim 8 wherein the offer request includes the Impression Goal and the Impression Maximum required of the offer.

11. The platform of claim 8 wherein the protocol is further configured to facilitate the transmission of an offer response to the offer request sent from the sell-side platform to the buy-side platform.

12. The platform of claim 11 wherein the protocol is further configured to facilitate the transmission of a list of sales units in the offer response sent from the sell-side platform to the buy-side platform.

13. The platform of claim 12 wherein the protocol is further configured to facilitate the transmission of efficient sales units that are available for sale in the offer response sent from the sell-side platform to the buy-side platform, defined by the lowest CPM, defined by the cost per thousand impressions of the target demographic.

14. The platform of claim 12 wherein the protocol is further configured to facilitate the transmission of the base number of inserted spots in efficient sales units that are available for sale limited so that the total impressions of the offer is less than the Impression Maximum requested—multiplying the impressions of each spot by the base number of inserted spots.

15. The platform of claim 12 wherein the protocol is further configured to facilitate the transmission of a recommended number of inserted spots for each of the most efficient sales units that are available for sale limited so that the total impressions of the offer for these recommended number of spots is greater than the Impression Goal requested, where the recommended number of spots does not exceed the separation goal within the Sales Unit and is equal to the base number of spots for the most efficient sales units and zero for all others of lower efficiency.

16. The platform of claim 1 wherein the protocol is further configured to facilitate the transmission of at least one booking from the buy-side platform to the sell-side platform.

17. The platform of claim 16 wherein the protocol is further configured to facilitate the transmission of bookings that are selected from the Offer by specifying the number of booking spots selected for each booking line.

18. The platform of claim 16 wherein the protocol is further configured to authenticate the buy-side platform.

19. The platform of claim 7 wherein the protocol is further configured to authenticate the buy-side platform via a user account.

20. The platform of claim 1 wherein the list of saleable sale units includes a list of base sales units directly defined over breaks.

21. The platform of claim 1 wherein the list of saleable sale units is extended by a list of group sales units defined by a list of child sale units.

22. A computerized process of determining pricing of a plurality of content inventory items to achieve a substantially optimized revenue delivered from an available inventory, the process comprising:
determining an inventory list of saleable sale units and CPMs available from a content inventory provider using at least one processor;
forecasting future impressions using the at least one processor; and
forecasting a demand of the inventory list of saleable sale units using the at least one processor; and
dynamically adjusting pricing based on the forecasted demand and the available inventory list of saleable sale units using the at least one processor.

23. The process of claim 22 wherein the operation of dynamically pricing comprises a rule based dynamic pricing.

24. The process of claim 23 wherein the rule based dynamic pricing comprises a rate weighted pacing ratio.

25. The process of claim 22 further comprises using a real-time inventory engine to determine incremental saleable sale units being booked.

26. The process of claim 22 wherein changes to a remaining capacity of the list of saleable sale units is determined using a real-time inventory engine.

27. The process of claim 26 wherein the change to the remaining capacity is used to increase a rate by rules.

28. The process of claim 26 wherein the change to the remaining capacity is used to clear a saleable flag by rules.

29. A computerized automated process comprising:
determining a CPM initial pricing for a list of target demographs together using at least one processor;
determining the remaining impressions for sale for each demograph using the at least one processor; and
changing the CPM rate based upon the forecast impression sales of all related demographs so that the revenue is maximized or improved using the at least one processor.
